(19) United States
(12) Patent Application Publication
(10) Pub. No.: US 2005/0086033 A1
(43) Pub. Date: Apr. 21, 2005

(54) Extracting semiconductor device model parameters

(75) Inventors: Ping Chen, San Jose, CA (US); Jushan Xie, Campbell, CA (US)

Correspondence Address: MORGAN, LEWIS & BOCKIUS, LLP., 2 PALO ALTO SQUARE, 3000 EL CAMINO REAL, PALO ALTO, CA, 94306, US

(73) Assignee: Cadence Design Systems, Inc.

(21) Appl. No.: 10/653,562

(22) Filed: Sep. 2, 2003

Related U.S. Application Data
(60) Provisional application No. 60/407,251, filed on Aug. 30, 2002.

(51) Int. Cl. G06F 17/10

(52) U.S. Cl. 703/2

(57) ABSTRACT

The present invention includes a method for extracting semiconductor device model parameters for a device model such as the BSIM4 model. The device model parameters for the device model includes a plurality of base parameters, DC model parameters, temperature dependent related parameters, and AC parameters. The method also includes steps for extracting various DC model parameters. The present invention also includes a method for extracting device model parameters including the steps of extracting a portion of the DC model parameters based on the terminal current data, modifying the terminal current data based on the extracted portion of the DC model parameters, and extracting a second portion of the DC model parameters based on the modified terminal current data.

### BACKGROUND OF THE INVENTION

1. Field of the Invention

The invention relates generally to computer-aided electronic circuit simulation, and more particularly, to a method of extracting semiconductor device model parameters for use in integrated circuit simulation.

2. Description of Related Art

Computer aids for electronic circuit designers are becoming more prevalent and popular in the electronic industry. This move toward electronic circuit simulation was prompted by the increase in both complexity and size of circuits. As circuits have become more complex, traditional breadboard methods have become burdensome and overly complicated. With increased computing power and efficiency, electronic circuit simulation is now standard in the industry. Examples of electronic circuit simulators include the Simulation Program with Integrated Circuit Emphasis (SPICE) developed at the University of California, Berkeley (UC Berkeley), and various enhanced versions or derivatives of SPICE, such as, SPICE2 or SPICE3, also developed at UC Berkeley; HSPICE, developed by Meta-software and now owned by Avant!; PSPICE, developed by Micro-Sim; and SPECTRE, developed by Cadence. SPICE and its derivatives or enhanced versions will be referred to hereafter as SPICE circuit simulators.

SPICE is a program widely used to simulate the performance of analog electronic systems and mixed mode analog and digital systems. SPICE solves sets of non-linear differential equations in the frequency domain, steady state and time domain and can simulate the behavior of transistor and gate designs. In SPICE, any circuit is handled in a node/element fashion; it is a collection of various elements (resistors, capacitors, etc.). These elements are then connected at nodes. Thus, each element must be modeled to create the entire circuit. SPICE has built in models for semiconductor devices, and is set up so that the user need only specify model parameter values.

An electronic circuit may contain any variety of circuit elements such as resistors, capacitors, inductors, mutual inductors, transmission lines, diodes, bipolar junction transistors (BJT), junction field effect transistors (JFET), and metal-on-silicon field effect transistors (MOSFET), etc. A SPICE circuit simulator makes use of built-in or plug-in models for semiconductor device elements such as diodes, BJTs, JFETs, and MOSFETs. If model parameter data is available, more sophisticated models can be invoked. Otherwise, a simpler model for each of these devices is used by default.

A model for a device mathematically represents the device characteristics under various bias conditions. For example, for a MOSFET device model, in DC and AC analysis, the inputs of the device model are the drain-to-source, gate-to-source, bulk-to-source voltages, and the device temperature. The outputs are the various terminal currents. A device model typically includes model equations and a set of model parameters. The model parameters, along with the model equations in the device model, directly affect the final outcome of the terminal currents. In order to represent actual device performance, a successful device model is tied to the actual fabrication process used to manufacture the device represented. This connection is represented by the model parameters, which are dependent on the fabrication process used to manufacture the device.

SPICE has a variety of preset models. However, in modern device models, such as BSIM (Berkeley Short-Channel IGFET Model) and its derivatives, BSIM3, BSIM4, and BSIMPD (Berkeley Short-Channel IGFET Model Partial Depletion), all developed at UC Berkeley, only a few of the model parameters can be directly measured from actual devices. The rest of the model parameters are extracted using nonlinear equations with complex extraction methods. See Daniel Foty, “MOSFET Modeling with Spice—Principles and Practice,” Prentice Hall PTR, 1997.

Since the sets of equations utilized in a modern semiconductor device model are complex with numerous unknowns, there is a need to extract the model parameters in the equations in an efficient and accurate manner so that using the extracted parameters, the model equations will closely emulate the actual process.

### SUMMARY OF THE INVENTION

The present invention includes a method for extracting semiconductor device model parameters for a device model such as the BSIM4 model. The device model parameters for the device model includes a plurality of base parameters, DC model parameters, temperature dependent related parameters, and AC parameters. The method includes steps for extracting the DC model parameters, such of Vₜₕ related parameters, I_{gb} related parameters, I_{gidl} related parameters, I_{gd} and I_{gs} related parameter, L_{eff}, R_{d} and Rₛ related parameters, mobility and W_{eff} related parameters, Vₜₕ geometry related parameters, sub-threshold region related parameters, drain induced barrier lower related parameters; I_{dsat} related parameters, and additional DC related parameters, based on the terminal current data corresponding to various bias conditions measured from a set of test devices.

The present invention also includes a method for extracting device model parameters including the steps of extracting a portion of the DC model parameters based on the terminal current data, modifying the terminal current data based on the extracted portion of the DC model parameters, and extracting a second portion of the DC model parameters based on the modified terminal current data.

### BRIEF DESCRIPTION OF THE DRAWINGS

FIG. 1 is a block diagram of a system according to an embodiment of the present invention;

FIG. 2 is a flow chart illustrating a modeling process in accordance with an embodiment of the present invention;

FIG. 3A is a block diagram of a model definition input file in accordance with an embodiment of the present invention;

FIG. 3B is a block diagram of an object definition input file in accordance with an embodiment of the present invention;

FIG. 4 is a diagrammatic cross sectional view of a MOSFET device for which model parameters are extracted in accordance with an embodiment of the present invention;

FIG. 5 is a graph illustrating sizes of test devices used to obtain experimental data for model parameter extraction in accordance with an embodiment of the present invention;

FIG. 6 is a graph illustrating sizes of test devices used to obtain experimental data for model parameter extraction in accordance with an alternative embodiment of the present invention;

FIGS. 7A-7D are examples of current-voltage (I-V) curves representing some of the terminal current data for the test devices;

FIG. 8 is a flow chart illustrating in further detail a parameter extraction process in accordance with an embodiment of the present invention; and

FIG. 9 is a flow chart illustrating in further detail a DC parameter extraction process in accordance with an embodiment of the present invention.

### DETAILED DESCRIPTION OF THE INVENTION

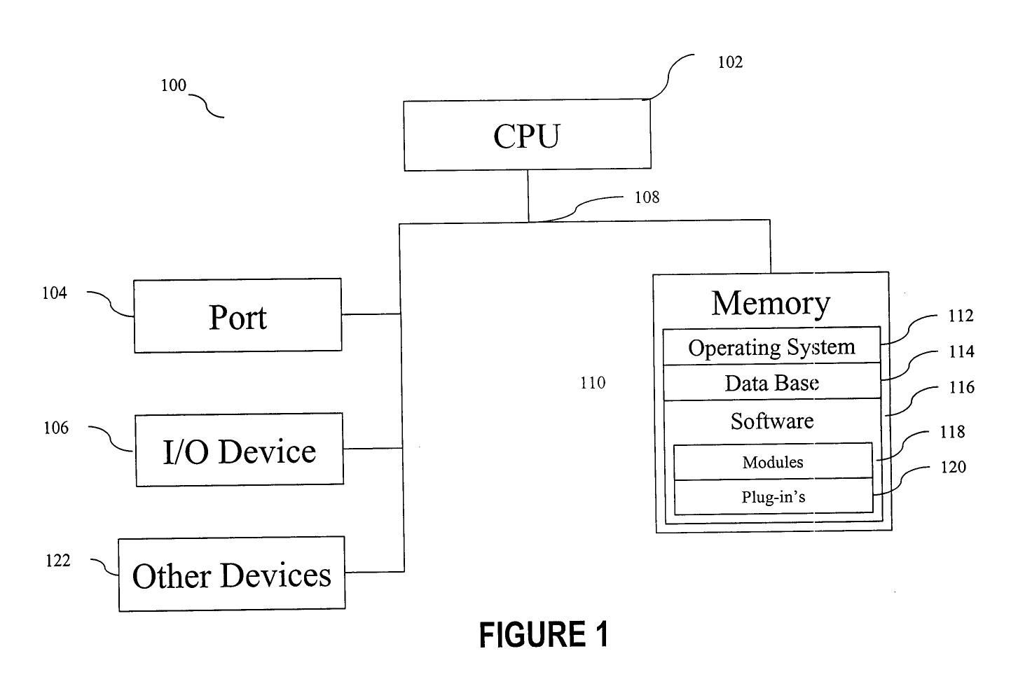

As shown in FIG. 1, system 100, according to one embodiment of the invention, comprises a central processing unit (CPU) 102, which includes a RAM, and a disk memory 110 coupled to the CPU 102 through a bus 108. The system 100 further comprises a set of input/output (I/O) devices 106, such as a keypad, a mouse, and a display device, also coupled to the CPU 102 through the bus 108. The system 100 may further include an input port 104 for receiving data from a measurement device (not shown), as explained in more detail below. The system 100 may also include other devices 122. An example of system 100 is a Pentium 233 PC/Compatible computer having RAM larger than 64 MB and a hard disk larger than 1 GB.

Memory 110 has computer readable memory spaces such as database 114 that stores data, memory space 112 that stores operating system 112 such as Windows 95/98/NT4.0/2000, which has instructions for communicating, processing, accessing, storing and searching data, and memory space 116 that stores program instructions (software) for carrying out the method of the present invention. Memory space 116 may be further subdivided as appropriate, for example to include memory portions 118 and 120 for storing modules and plug-in models, respectively, of the software.

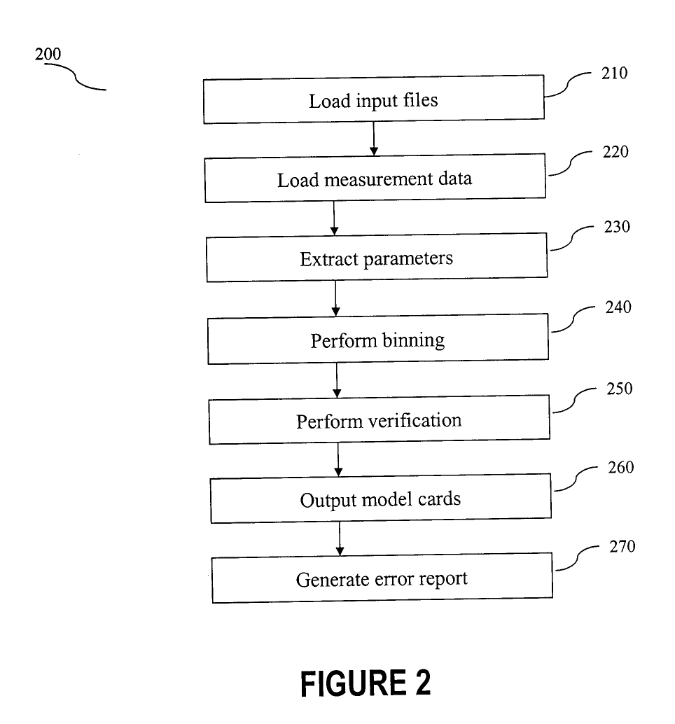

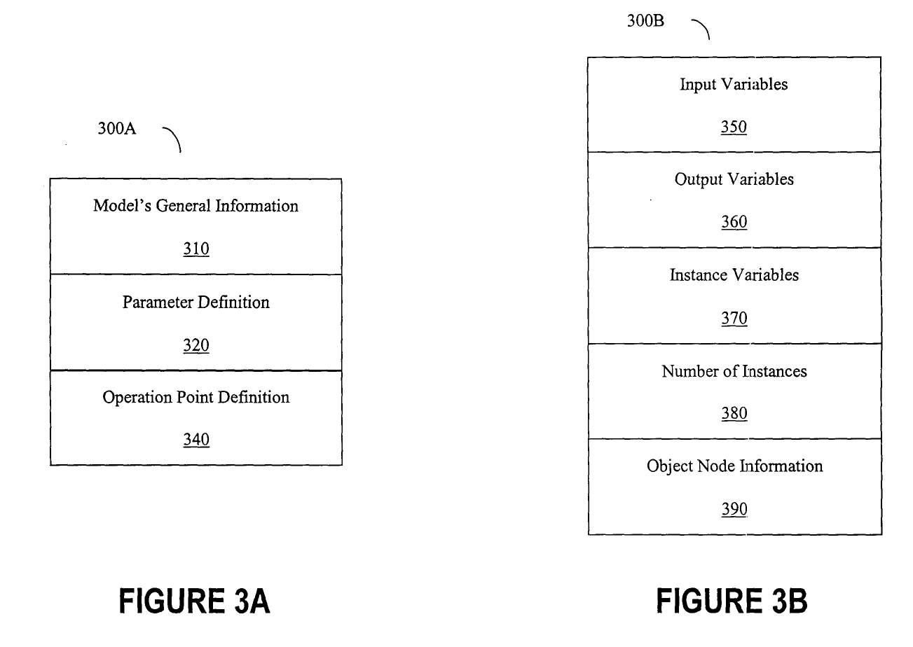

A set of model parameters for a semiconductor device is often referred to as a model card for the device. Together with the model equations, the model card is used by a circuit simulator to emulate the behavior of the semiconductor device in an integrated circuit. A model card may be determined by process 200 as shown in FIG. 2. Process 200 begins by loading 210 the input files into the RAM of the CPU 102. The input files may include a model definition file and an object definition file. The object definition file provides information of the object (device) to be simulated. The model definition file provides information associated with the device model for modeling the behavior of the object. These files are discussed in further detail below in conjunction with FIGS. 3A and 3B.

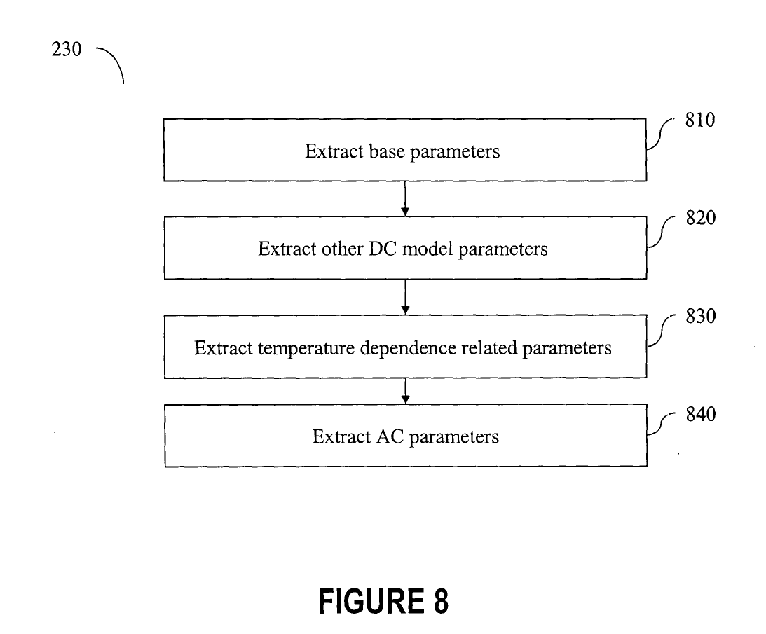

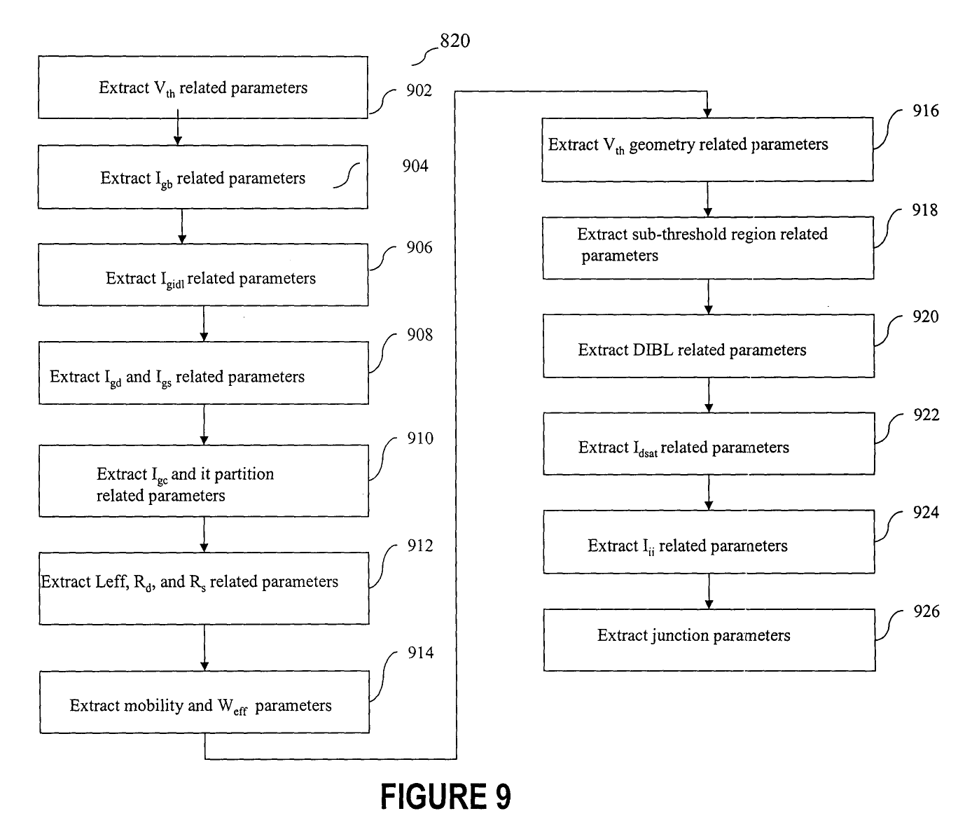

Next, the measurement data is loaded 220 from database 114. The measurement data includes physical measurements from a set of test devices, as will be explained in more detail below. Once the data has been loaded, the next step is extraction 230 of the model parameters. The parameter extraction step 230 is discussed in detail in connection with FIGS. 8, and 9 below.

After the parameters are extracted, binning 240 may be performed. Binning is an optional step depending on whether the device model is binnable or not. The next step is verification 250. Verification checks the quality of the extracted model parameters. Once verified, the extracted parameters are output 260 as model card, an error report is generated 270, and the process 200 is then complete. More detailed discussion about the binning step 240 and verification step 250 can be found in the BSIMPro+User Manual—Basic Operation, by Celestry Design Technologies, released in September, 2001, which is incorporated by reference in its entirety herein.

Referring to FIG. 3A, model definition file 300A comprises a general model information field 310, a parameter definition field 320, an intermediate variable definition field 330, and an operation point definition field 340. The general model information field 310 includes general information about the device model, such as model name, model version, compatible circuit simulators, model type and binning information. The parameter definition field 320 defines the parameters in the model. As an example, a list of the model parameters in the BSIM4 model are provided in Appendix A. For each parameter, the model definition file specifies information associated with the parameter, such as parameter name, default value, parameter unit, data type, and optimization information. The operation point definition section 340 defines operation point or output variables, such as device terminal currents, threshold voltage, etc., used by the model.

Referring to FIG. 3B, object definition file 300B defines object related information, including input variables 350, output variables 360, instance variables 370, object and node information 380. Input variables 350 and output variables 360 are associated with the inputs and outputs, respectively, of the device in an integrated circuit. The instance variables 370 are associated with the geometric characteristics of the device to be modeled. The object node information 380 is the information regarding the nodes or terminals of the device to be modeled.

Process 200 can be used to generate model cards for models describing semiconductor devices such as BJTs, JFETs, and MOSFETs, etc. Discussions about the use of some of these models can be found in the BSIMPro+User Manual—Device Modeling Guide, by Celestry Design Technologies, released in September, 2001, which is incorporated by reference in its entirety herein. As an example, the BSIM4 model, which was developed by UC Berkeley to model MOSFET devices, is used here to further describe the parameter extraction step 230 of the process 200. The model equations for the BSIM4 model are provided in Appendix B. More detailed discussion about the BSIM4 model can be found in the BSIM4.2.0 MOSFET Model Users' Manual by the Department of Electrical Engineering and Computer Sciences, UC Berkeley, Copyright 2001, which is incorporated by reference in its entirety herein.

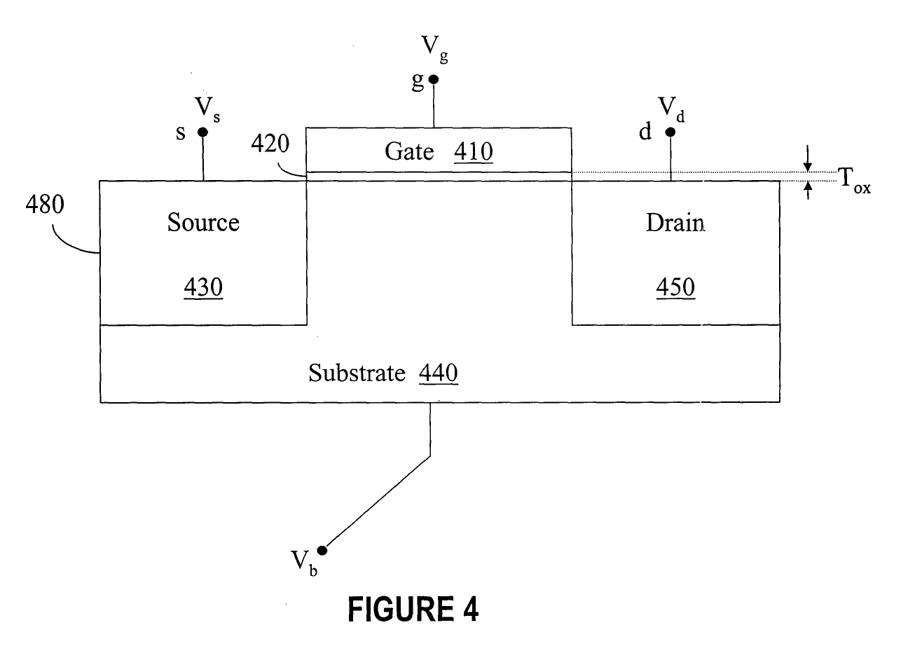

Preferred embodiments of the present invention, thus may be further understood by reference to an exemplary parameter extraction process for a MOSFET device. As shown in FIG. 4, a MOSFET device 400 includes a source 430 and a drain 450 formed in a substrate 440. The MOSFET also includes a gate 410 over the substrate 440 and is separated from the substrate 440 by a thin layer of gate oxide 420.

The MOSFET as described can be considered a four terminal (node) device. The four terminals are the gate terminal (node g), the source terminal (node s), the drain terminal (node d), and the substrate or body terminal (node b). Nodes g, s, b, and d, can be connected to different voltage sources.

For ease of further discussion, Table I below lists the symbols corresponding to the physical variables associated with the operation of MOSFET device 400.

TABLE I

| | |
|---|---|
| C_{bd} - | body to drain capacitance |
| C_{bS} - | body to source capacitance |
| I_{d} - | current through drain (d) node |
| I_{dgidl} - | gate induced leakage current at the drain |
| I_{ds} - | current flowing from source to drain |
| I_{dsat} - | drain saturation current |
| I_{b} - | current through substrate node |
| I_{gb} - | gate oxide tunneling current to substrate |
| I_{gs} - | current flowing from gate to source |
| I_{gd} - | current flowing from gate to drain |
| I_{gc} - | current flowing from gate to channel |
| I_{sub} - | impact ionization current |
| Iₛ - | current through source (s) node |
| L_{gisl} - | gate induced source leakage current at the source |
| L_{drawn} - | drawn channel length |
| L_{eff} - | effective channel length |
| R_{d} - | drain resistance |
| Rₛ - | source resistance |
| R_{ds} - | drain/source resistance |
| Rₒᵤₜ - | output resistance |
| V_{bs} - | voltage between node b and node s |
| V_{d} - | drain voltage |
| V_{DD} - | maximum operating DC voltage |
| V_{ds} - | voltage between node d and node s |
| V_{b} - | substrate voltage |
| V_{g} - | gate voltage |
| V_{gs} - | voltage between node g and node s |
| Vₛ - | source voltage |
| Vₜₕ - | threshold voltage |
| W_{drawn} - | drawn channel width |
| W_{eff} - | effective channel width |

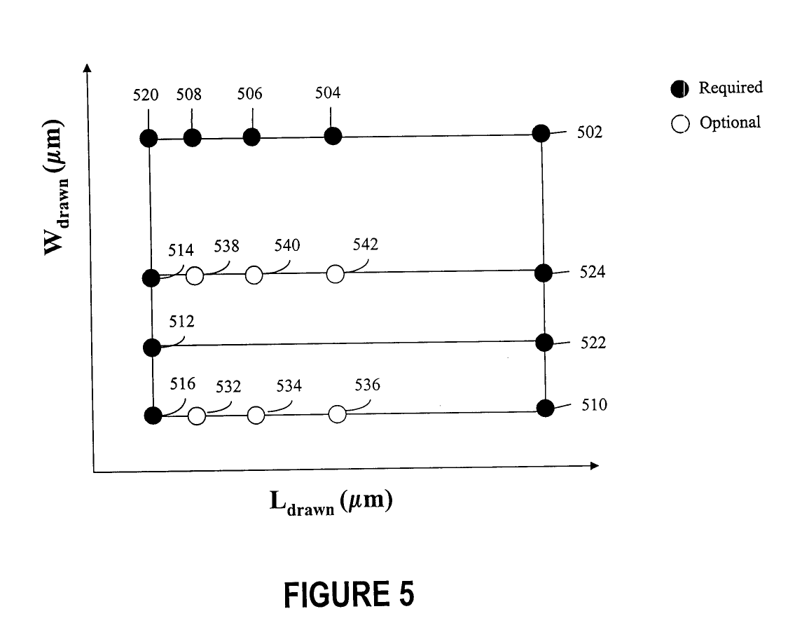

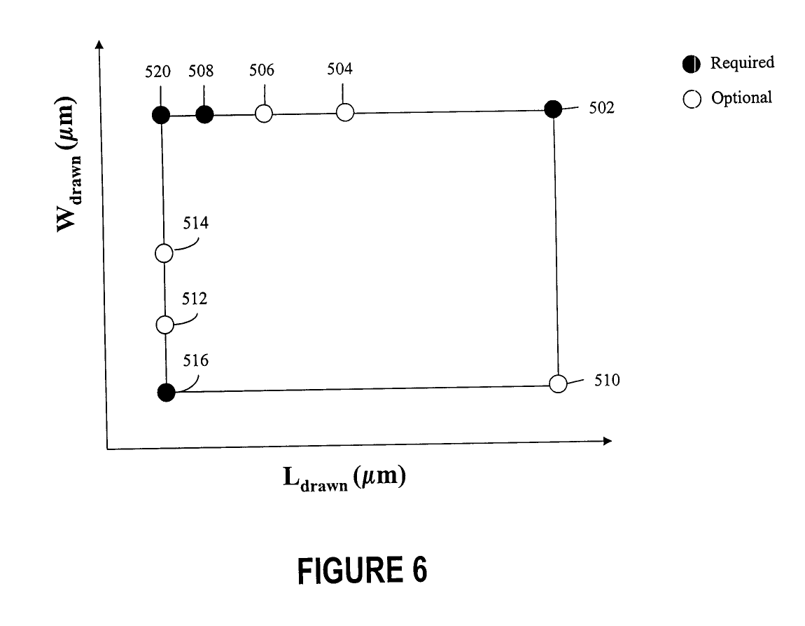

In order to model the behavior of the MOSFET device 400 using the BSIM4 model, experimental data are used to extract model parameters associated with the model. These experimental data include terminal current data and capacitance data measured in test devices under various bias conditions. In one embodiment of the present invention, the measurement is done using a conventional semiconductor device measurement tool that is coupled to system 100 through input port 104. The measured data are thus organized by CPU 102 and stored in database 114. The test devices are typically manufactured using the same or similar process technologies for fabricating the MOSFET device. In one embodiment of the present invention, a set of test devices having different device sizes, meaning different channel widths and channel lengths are used for the measurement. The device size requirement can vary with different applications. Ideally, as shown in FIG. 5, the set of devices include:
one largest device, meaning the device with the longest drawn channel length and widest drawn channel width that is available, as represented by dot 502;
one smallest device, meaning the device with the shortest drawn channel length and smallest drawn channel width that is available, as represented by dot 516;
one device with the smallest drawn channel width and longest drawn channel length, as represented by dot 510;
one device with the widest drawn channel length and shortest drawn channel length, as represented by dot 520;
three devices having the widest drawn channel width and different drawn channel lengths, as represented by dots 504, 506, and 508;
two devices with the shortest drawn channel length and different drawn channel widths, as represented by dots 512 and 514;
two devices with the longest drawn channel length and different drawn channel widths, as represented by dots 522 and 524;
(optionally) up to three devices with smallest drawn channel width and different drawn channel lengths, as represented by dots 532, 534, and 536; and
(optionally) up to three devices with medium drawn channel width (about halfway between the widest and smallest drawn channel width) and different drawn channel lengths, as represented by dots 538, 540, and 542.
   If in practice, it is difficult to obtain measurements for all of the above required devices sizes, a smaller set of different sized devices can be used. For example, the different device sizes shown in FIG. 6 are sufficient according to an alternative embodiment of the present invention. The test devices as shown in FIG. 6 include:
one largest device, meaning the device with the longest drawn channel length and widest drawn channel width, as represented by dot 502;
one smallest device, meaning the device with the shortest drawn channel length and smallest drawn channel width, as represented by dot 516;
(optional) one device with the smallest drawn channel width and longest drawn channel length, as represented by dot 510;
one device with the widest drawn channel width and shortest drawn channel length, as represented by dot 520;
one device and two optional devices having the widest drawn channel width and different drawn channel lengths, as represented by dots 504 (optional), 506 (optional), and 508, respectively;
(optional) two devices with the shortest drawn channel length and different drawn channel widths, as represented by dots 512 and 514.

For each test device, terminal currents are measured under different terminal bias conditions. These terminal current data are put together as I-V curves representing the I-V characteristics of the test device. In one embodiment of the present invention, for each test device, the following I-V curves are obtained:
1. Linear region I_{d} vs. V_{gs} curves for a set of V_{b} values. These curves are obtained by grounding the s node, setting V_{d} to a low value, such as 0.05V, and for each of the set of V_{b} values, measuring I_{d} while sweeping V_{g} in step values across a range such as from 0 to V_{DD}. (−V_{DD} for NMOS _{and} V_{DD} for PMOS).
2. Saturation region I_{d} vs. V_{gs} curves for a set of V_{b} values. These curves are obtained by grounding the s node, setting V_{d} to a high value, such as V_{DD}, and for each of the set of V_{b} values, measuring I_{d} while sweeping V_{g} in step values across a range such as from 0 to V_{DD}. (−V_{DD} for NMOS _{and} V_{DD} for PMOS).
3. Saturation region I_{d} VS V_{ds} curves for a set of V_{g} values. These curves are obtained by grounding the s node, setting V_{b} to 0 and for each set of V_{g} values, measuring I_{d} while sweeping V_{d} in step values across a range such as Vₜₕ+0.02 to V_{DD}.
4. Linear region I_{d} vs V_{ds} curves for a set of V_{g} values with substrate biased. These curves are obtained by grounding the s node, setting V_{b} to −V_{DD} and for each set of V_{g} values, measuring I_{d} while sweeping V_{d} in step values across a range such as Vₜₕ+0.02 to V_{DD}.
5. I_{b} vs. V_{gs} curves for different V_{d} values, obtained by grounding the s and b nodes, and for each of the set of V_{d} values, measuring I_{b} while sweeping V_{g} in step values across a range such as from 0 to V_{DD}.
6. I_{g} vs. V_{bs} curves obtained by grounding d, g, and s nodes, measuring I_{g} while sweeping V_{b} in step values across a range such as from −V_{DD} to 0.7.
7. I_{g}/I_{d}/Iₛ vs. V_{gs} curves for different V_{d} values, obtained by grounding s and b nodes, and for each of a set of V_{d} values sweeping V_{g} in step values across a range such as from 0 to V_{DD}.
8. Iₛ vs. V_{gd} curves for different V_{b} and Vₛ values, obtained by grounding d node, and for each combination of V_{b}, and Vₛ values, measuring Iₛ while sweeping V_{g} in step values across a range such as from 0 to −V_{DD}.

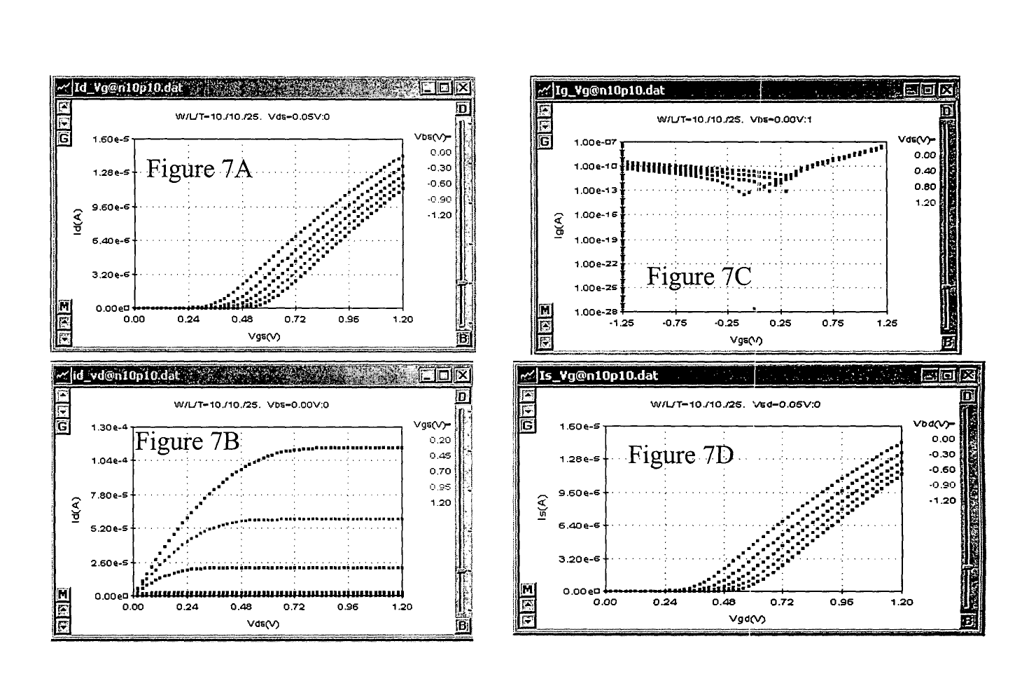

As examples, FIG. 7A shows a set of linear region I_{d} vs. V_{gs} curves for different V_{bs} values, FIG. 7B shows a set of saturation region I_{d} vs. V_{ds} curves for different V_{gs} values, FIG. 7C shows a set of I_{g} vs. V_{gs} curves for different V_{ds} values; and FIG. 7D shows a set of I_{g} vs. V_{gs} curves for different V_{bd} values.

In addition to the terminal current data, for each test device, capacitance data are also collected from the test devices under various bias conditions. The capacitance data can be put together into capacitance-current (C-V) curves. In one embodiment of the present invention, the following C-V curves are obtained:
1. C_{bs} VS. V_{bs} curve obtained by grounding s node, setting I_{d} to zero, or to very small values, and measuring C_{bs} while sweeping V_{b} in step values across a range such as from −V_{DD} to V_{DD}.
2. C_{bd} vs. V_{bs} curve obtained by grounding s node, setting Iₛ to zero, or to very small values, and measuring C_{bd} while sweeping V_{b} in step values across a range such as from −V_{DD} to V_{DD}.

As shown in FIG. 8, in one embodiment of the present invention, the parameter extraction step 230 comprises extracting base parameters 810; extracting other DC model parameters 820; extracting temperature dependent related parameters 830; and extracting AC parameters 840. In base parameters extraction step 810, base parameters, such as Vₜₕ (the threshold voltage at V_{bs}=0), K₁ (the first order body effect coefficient), and K₂ (the second order body effect coefficient) are extracted based on process parameters corresponding to the process technology used to fabricate the MOSFET device to be modeled. The base parameters are then used to extract other DC model parameters at step 820, which is explained in more detail in connection with FIG. 9 below.

The temperature dependent parameters are parameters that may vary with the temperature of the device and include parameters such as: Kt1 (temperature coefficient for threshold voltage); Ua1 (temperature coefficient for Uₐ), and Ub1 (temperature coefficient for U_{b}), etc. These parameters can be extracted using a conventional parameter extraction method.

The AC parameters are parameters associated with the AC characteristics of the MOSFET device and include parameters such as: CLC (constant term for the short channel model) and moin (the coefficient for the gate-bias dependent surface potential), etc. These parameters can also be extracted using a conventional parameter extraction method.

As shown in FIG. 9, the DC parameter extraction step 820 further comprises: extracting Vₜₕ related parameters (step 902); extracting I_{gb} related parameters (step 904); extracting I_{gidl} related parameters (step 906); extracting I_{gd} and I_{gs} related parameters (step 908); extracting I_{gc} and its partition (I_{gcs} and I_{gcd}) related parameters (step 910); extracting L_{eff} related parameters, R_{d} related parameters, and Rₛ related parameters (step 912); extracting mobility related parameters and W_{eff} related parameters (step 914); extracting Vₜₕ geometry related parameters (step 916); extracting sub-threshold region related parameters (step 918); extracting parameters related to drain-induced barrier lower than regular (DIBL) (step 920); extracting I_{dsat} related parameters (step 922); extracting I_{sub} related parameters (step 924); and extracting junction parameters (step 926).

The equation numbers below refer to the equations set forth in Appendix B.

In step 902, threshold voltage Vₜₕ related parameters, such as Vₜₕ₀, k1, k2, and Ndep, are extracted by using the linear I_{d} vs V_{gs} curves measured from the largest device.

In step 904, the tunneling current, Igb, related parameters are extracted. The tunneling current is comprised of two components as defined by the following equation:
I_{gb}=Igbacc+Igbinv

Igbacc and Igbinv related parameters are extracted separately in step 904. For the extraction of Igbacc related parameters, the I_{g} vs. V_{bs} curves for V_{ds}=0 and V_{gs}=0 are used. V_{ds} and V_{gs} are set to zero to minimize the effects of other currents. Then model parameters Aigbacc, Bigbacc, and Cigbacc are extracted with nonlinear-square-fit, using Equation 4.3.1. Once these parameters are extracted, Nigbacc is obtained by linear interpolation of Equation 4.3.1b using maximum slope position in the I_{g} vs. V_{bs} curves.

For the extraction of Igbinv related parameters, the I_{b} vs. V_{gs} curves when V_{ds}=0 and V_{bs}=0 are used. V_{ds} and V_{bs} are set to zero to minimize the effects of other currents. Model parameters Aigbinv, Bigbinv, Cigbinv are then extracted with nonlinear-square-fit, using Equation 4.3.2. Then Nigbinv and Eigbinv are obtained using Equation 4.3.2a by conventional optimization methods such as the Newton-Raphson algorithm.

In step 906, I_{gidl}-related parameters, such as parameters AGIDL, BGIDL, CGIDL, and EGIDL, are extracted. I_{gidl} represents the gate-induced drain leakage current, and the parameters are extracted using the device with the maximum width, W, and data from the I_{d} VS V_{gs} and Iₛ vs V_{gs} curves measured at the condition of V_{gs}<0 for NMOS (V_{gs}>0 for PMOS) and at different V_{ds} and V_{bs} bias conditions. I_{sub} is negligible where V_{gs}<0 and therefore the I_{b} vs V_{gs} curve can be used for this extraction. These assumptions and curves are used in conjunction with the extracted Vₜₕ, related parameters from step 902 and the following equation:

$$\begin{matrix}{I}_{GIDL} = AGIDL \cdot {W}_{effCJ} \cdot Nf \cdot \frac{{V}_{ds} - {V}_{gse} - EGIDL}{3 \cdot {T}_{oxe}} \cdot \\ exp ( - \frac{3 \cdot {T}_{oxe} \cdot BGIDL}{{V}_{ds} - {V}_{gse} - EGIDL} ) \cdot \frac{{V}_{db}^{3}}{CGIDL + {V}_{db}^{3}}\end{matrix}$$

CGIDL is extracted using the I_{b} vs V_{gs} curve data for varying V_{ds}. Next AIGDL and BIGDL are extracted using a conventional non-linear square fit. Finally EGIDL is obtained by optimizing AGIDL, BGIDL, and EGIDL simultaneously using a conventional optimizer such as the Newton-Raphson algorithm.

In step 908, the gate to source, I_{gs}, and gate to drain, I_{gd} current parameters are extracted. I_{gs} represents the gate tunneling current between the gate and the source diffusion region, I_{gd} represents the gate tunneling current between the gate and the drain diffusion region. Parameters extracted in step 908 include DLCIG, AIGSD, BIGSD, and CIGSD. The values of the parameters POXEDGE, TOXREF, and NTOX are set to their default values. These parameters are extracted using the I_{d} vs V_{gs} and Iₛ vs V_{gs} curves measured at the condition of V_{ds}=0 and V_{bs}=0. V_{ds} and V_{bs} are set equal to zero to minimize the effects of other currents such as channel current. This extraction utilizes the device with the maximum L_{drawn}*W_{drawn}, where L_{drawn} is the device channel length and W_{drawn} is the device width, and the extracted Vₜₕ, related parameters from step 902.

The following equations are utilized:
I_{gs}=W_{eff}DLCIG·A·T_{oxRatioEdge}·V_{gs}·V′_{gs}·exp[−B·TOXE·POXEDGE·(AIGSD−BIGSD·V′_{gs})·(1+CIGSD·V′_{gs})]
and
I_{gd}=W_{eff}DLCIG·A·T_{oxRatioEdge}·V_{gd}·V′_{gd}·exp[−B·TOXE·POXEDGE·(AIGSD−BIGSD·V′_{gd})·(1+CIGSD·V′_{gd})]
where

$${T}_{oxRatioEdge} = {( \frac{TOXREF}{TOXE \cdot POXEDGE} )}^{NTOX} \cdot \frac{1}{{( TOXE \cdot POXEDGE )}^{2}}$$

and
V′_{gs}\sqrt{(V_{gs}−V_{fbsd})²+1.0e−4}
V_{gd}=\sqrt{(V_{gd}−V_{fbsd})²+1.0e−4}
DLCIG is set equal to 0.7 *Xⱼ which is a proven experimental value. Then AIGSD, BIGSD, and CIGSD are extracted from the I_{d}/Iₛ vs V_{gs} curve using the non-linear square fit method.

In step 910, the gate to current, I_{gc}, and it's partition related parameters are extracted. Parameters extracted in step 910 includes: AIGC, BIGC, CIGC, NIGC and P_{igcd}. These parameters are extracted using the device with the maximum L_{drawn}*W_{drawn} and the data from the I_{g} vs V_{gs} curve measured at the condition of V_{ds}=0 and V_{bs}=0. V_{ds} and V_{bs} are set equal to zero to minimize the effects of other currents such as channel current. The data of I_{g} includes I_{gc}, I_{gs} and I_{gd} data and is characterized by the following equation.
I_{g}=I_{gc}+I_{gs}+I_{gd}
Since I_{gs} and I_{gd} are extracted in earlier steps, these effects can easily be removed with the calculated I_{gs} and I_{gd}. I_{gc} is then calculated using the extracted Vₜₕ, related parameters from step 902, in coordination data from the I_{g} vs V_{gs} curve and the following equation:
I_{gc}=W_{eff}L_{eff}·A·T_{oxRatio}·V_{gse}Vₐᵤₓ·exp[−B·TOXE(AIGC−BIGC·V_{oxdepinv})·(1+CIGC·V_{oxdepinv})]
Where

$${V}_{aux} = NIGC \cdot {v}_{t} \cdot log ( 1 + exp ( \frac{{V}_{gse} - VTH0}{NIGC \cdot {v}_{t}} ) )$$

Using a non-linear square fit, AIGC, BIGC, and CIGC are extracted. NIGC is then extracted at V_{gs}=Vₜₕ₀ using linear interpolation.

Once calculated, Igc is then divided into its two components I_{gcs} and I_{gcd}

$$\begin{matrix}{I}_{gcs} = {I}_{gc} \cdot \frac{PIGCD \cdot {V}_{ds} + exp ( - PIGCD \cdot {V}_{ds} ) - 1 + 1.0 e - 4}{{PIGCD}^{2} \cdot {V}_{ds}^{2} + 2.0 e - 4} \\ {I}_{gcd} = {I}_{gc} \cdot \frac{1 - ( PIGCD \cdot {V}_{ds} + 1 ) \cdot exp ( - PIGCD \cdot {V}_{ds} ) + 1.0 e - 4}{{PIGCD}^{2} \cdot {V}_{ds}^{2} + 2.0 e - 4}\end{matrix}$$

and

In step 912, parameters related to the effective channel length L_{eff}, the drain resistance R_{d} and source resistance Rₛ are extracted. The L_{eff}, R_{d} and Rₛ related parameters include parameters such as Lᵢₙₜ, and R_{dsw}, and are extracted using data from the linear I_{d} vs V_{gs} curves as well as the extracted Vₜₕ related parameters from step 902.

In step 914, parameters related to the mobility and effective channel width W_{eff}, such as μ₀, Uₐ, U_{b}, U_{c}, Wint, Wr, Prwb, Wr, Prwg, R_{dsw}, Dwg, and Dwb, are extracted, using the linear I_{d} VS V_{gs} curves and the extracted Vₜₕ, related parameters from step 902.

Steps 902, 912, and 914 can be performed using a conventional BSIM4 model parameter extraction method. Discussions about some of the parameters involved in these steps can be found in the following:
Liu, William “MOSFET Models for SPICE Simulation, Including BSIM3v3 and BSIM4,” John Wiley & Sons, Inc. 2001
   which is incorporated by reference herein.

In step 916, the threshold voltage Vₜₕ geometry related parameters, such as D_{VT0}, D_{VT1}, D_{VT2}, N_{LX1}, D_{VT0W}, D_{VT1W}, D_{VT2W}, k₃, and k_{3b}, are extracted, using the linear I_{d} vs V_{gs} curve, the extracted Vₜₕ, L_{eff}, and mobility and W_{eff} related parameters from steps 902, 912, and 914, and Equations 2.5.5-2.5.7.

In step 918, sub-threshold region related parameters, such as Cᵢₜ, Nfactor, V_{off}, D_{dsc}, and C_{dscd}, are extracted, using the linear I_{d} vs V_{gs} curves, the extracted Vₜₕ, L_{eff} and R_{d} and Rₛ and mobility and W_{eff} related parameters from steps 902, 912, and 914, and Equations (3.2.1-3.2.3.

In step 920, DIBL related parameters, such as D_{sub}, Eta0 and Etab, are extracted, using the saturation I_{d} vs V_{gs} curves and the extracted Vₜₕ related parameters from step 902, and Equations 2.5.5-2.5.7.

In step 922, the drain saturation current I_{dsat} related parameters, such as B0, B1, A0, Keta, and A_{gs}, are extracted using the saturation I_{d} VS V_{ds} curves, the extracted Vₜₕ, L_{eff} and R_{d} and Rₛ, mobility and W_{eff}, Vₜₕ geometry, sub-threshold region, and DIBL related parameters from steps 902, 912, 914, 916, 918, and 920 and Equation 14.1.

In step 924, the impact ionization current Iᵢᵢ related parameters, such as α₀, α₁, and β₀, are extracted using the data from the linear I_{d} VS V_{gs} curve and Equations 6.1.1-6.1.2.

In step 926, the junction parameters, such as Cjswg, Pbswg, and Mjswg, are extracted using the C_{bs} VS. V_{bs} and C_{bd} vs. V_{bs} curves, and Equations 10.2.1-10.2.7.

In performing the DC parameter extraction steps (steps 902-926), it is preferred that after the I_{gb}, I_{gd}, I_{gs} I_{gidl}, and I_{gc} related parameters are extracted in steps 904 through 910, I_{gb}, I_{gd}, I_{gs}, I_{gidl}, and I_{gc} are calculated based on these parameters and the model equations. This calculation is done for the bias condition of each data point in the measured I-V curves. The I-V curves are then modified for the first time based on the calculated I_{gb}, I_{gd}, I_{gs}, I_{gidl}, and I_{gc} values. In one embodiment of the present invention, the I-V curves are first modified by subtracting the calculated I_{gb}, I_{gd}, I_{gs}, I_{gidl}, and I_{gc} values from respective Iₛ, I_{d}, and I_{b} data values. For example, for a test device having drawn channel length L_{drn} and drawn channel width W_{drn}, if under bias condition where Vₛ=Vₛ^{T}, V_{d}=V_{d}^{T}, Vₚ=Vₚ^{T}, Vₑ=Vₑ^{T}, and V_{g}=V_{g}^{T}, the measured drain current is I_{d}^{T}, then after the first modification, the drain current will be I_{d}^{first-modified}=I_{d}^{T}−I_{gd}^{T}−I_{gidl}^{T} where I_{gd}^{T} and I_{gidl}^{T}, are calculated respectively, for the same test device under the same bias condition. The first-modified I-V curves are then used for additional DC parameter extraction. This results in higher degree of accuracy in the extracted parameters. In one embodiment the I_{gb}, I_{gd}, I_{gs}, I_{gidl} and I_{gc} related parameters are extracted before extracting other DC parameters, so that I-V curve modification may be done for more accurate parameter extraction. However, if such accuracy is not required, one can choose not to do the above modification and the I_{gb}, I_{gd}, I_{gs}, I_{gidl}, and I_{gc} related parameters can be extracted at any point in the DC parameter extraction step 820.

The forgoing descriptions of specific embodiments of the present invention are presented for purpose of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Furthermore, the order of the steps in the method are not necessarily intended to occur in the sequence laid out. It is intended that the scope of the invention be defined by the following claims and their equivalents.

APPENDIX A
Parameter List

| | | | | |
|---|---|---|---|---|
| Parameter | | Default | | |
| name | Description | value | Binnable? | Note |

A.1 BSIM 4.0.0 Model Selectors/Controllers

| | | | | |
|---|---|---|---|---|
| (LEVEL | SPICE3 model selector | 14 | NA | BSIM4 |
| SPICE3 | | | | also set as |
| parameter) | | | | the default |
| | | | | model in |
| | | | | SPICE3 |
| VERSION | Model version number | 4.0.0 | NA | Berkeley |
| | | | | Latest |
| | | | | official |
| | | | | release |
| BINUNIT | Binning unit selector | 1 | NA | — |
| PARAMCHK | Switch for parameter value check | 1 | NA | Parameters |
| | | | | checked |
| MOBMOD | Mobility model selector | 0 | NA | — |
| RDSMOD | Bias-dependent source/drain | 0 | NA | R_{ds}(V) |
| | resistance model selector | | | modeled |
| | | | | internally |
| | | | | through IV |
| | | | | equation |
| IGCMOD | Gate-to-channel tunneling current | 0 | NA | OFF |
| | model selector | | | |
| IGBMOD | Gate-to-substrate tunneling current | 0 | NA | OFF |
| | model selector | | | |
| CAPMOD | Capacitance model selector | 2 | NA | — |
| RGATEMOD | Gate resistance model selector | 0 | | |
| (Also an | | (no gate | | |
| instance | | resistance) | | |
| parameter) | | | | |
| RBODYMOD | Substrate resistance network model | 0 | NA | — |
| (Also an | selector | (network | | |
| instance | | off) | | |
| parameter) | | | | |
| TRNQSMOD | Transient NQS model selector | 0 | NA | OFF |
| (Also an | | | | |
| instance | | | | |
| parameter) | | | | |
| ACNQSMOD | AC small-signal NQS model | 0 | NA | OFF |
| (Also an | selector | | | |
| instance | | | | |
| parameter) | | | | |
| FNOIMOD | Flicker noise model selector | 1 | NA | — |
| TNOIMOD | Thermal noise model selector | 0 | NA | — |
| DIOMOD | Source/drain junction diode IV | 1 | NA | — |
| | model selector | | | |
| PERMOD | Whether PS/PD (when given) | 1 | NA | — |
| | includes the gate-edge perimeter | (including | | |
| | | the gate- | | |
| | | edge | | |
| | | perimeter) | | |
| GEOMOD | Geometry-dependent parasitics | 0 | NA | — |
| (Also an | model selector - specifying how the | (isolated) | | |
| instance | end S/D diffusions are connected | | | |
| parameter) | | | | |
| RGEOMOD | Source/drain diffusion resistance | 0 | NA | — |
| (Instance | and contact model selector - | (no S/D | | |
| parameter | specifying the end S/D contact type: | diffusion | | |
| only) | point, wide or merged, and how | resistance) | | |
| | S/D parasitics resistance is | | | |
| | computed | | | |

A.2 Process Parameters

| | | | | |
|---|---|---|---|---|
| EPSROX | Gate dielectric constant relative to | 3.9 (SiO₂) | No | Typically |
| | vacuum | | | greater |
| | | | | than or |
| | | | | equal to |
| | | | | 3.9 |
| TOXE | Electrical gate equivalent oxide | 3.0e−9m | No | Fataleno |
| | thickness | | | r if not |
| | | | | positive |
| TOXP | Physical gate equivalent oxide | TOXE | No | Fatalerro |
| | thickness | | | r if not |
| | | | | positive |
| TOXM | Tox at which parameters are extracted | TOXE | No | Fatal |
| | | | | error if |
| | | | | not |
| | | | | positive |
| DTOX | Defined as (TOXE-TOXP) | 0.0 m | No | — |
| XJ | S/D junction depth | 1.5e−7m | Yes | — |
| GAMMA1 | Body-effect coefficient near the surface | calculated | V^{1/2} | Note-1 |
| (λ1 in | calculated | | | |
| equation) | | | | |
| GAMMA2 | Body-effect coefficient in the bulk | calculated | V^{1/2} | Note-1 |
| (λ1 in | | | | |
| equation) | | | | |
| NDEP | Channel doping concentration at | 1.7e17cm⁻3 | Yes | Note-2 |
| | depletion edge for zero body bias | | | |
| NSUB | Substrate doping concentration | 6.0e16cm⁻3 | Yes | — |
| NGATE | Poly Si gate doping concentration | 0.0 cm⁻³ | Yes | — |
| NSD | Source/drain doping concentrationFatal | 1.0e20cm⁻³ | Yes | — |
| | error if not positive | | | |
| VBX | V_{b s} at which the depletion region | calculated | No | Note-3 |
| | width equalsXT | (V) | | |
| XT | Doping depth | 1.55e−7m | Yes | — |
| RSH | Source/drain sheet resistance | 0.0 ohm/ | No | Should |
| | | square | | not be |
| | | | | negative |
| RSHG | Gate electrode sheet resistance | 0.1 ohm/ | No | Should |
| | | square | | not be |
| | | | | negative |

A.3 Basic Model Parameters

| | | | | |
|---|---|---|---|---|
| VTH0 or | Long-channel threshold voltage at | 0.7 V | Yes | Note-4 |
| VTHO | V_{bs} = 0 | (NMOS) | | |
| | | −0.7 V | | |
| | | (PMOS) | | |
| VEB | Flat-band voltage | −1.0 V | Yes | Note-4 |
| PHLN | Non-uniform vertical doping effect on | 0.0 V | Yes | — |
| | surface potential | | | |
| K1 | First-order body bias coefficient | 0.5 V^{1/2} | Yes | Note-5 |
| K2 | Second-order body bias coefficient | 0.0 | Yes | Note-5 |
| K3 | Narrow width coefficient | 80.0 | Yes | − |
| K3B | Body effect coefficient of K3 | 0.0 V⁻¹ | Yes | — |
| W0 | Narrow width parameter | 2.5e−6m | Yes | — |
| LPE0 | Lateral non-uniform doping parameter | 1.74e−7m | Yes | — |
| | at V_{bS} = 0 | | | |
| LPEB | Lateral non-uniform doping effect on | 0.0 m | Yes | — |
| | K1 | | | |
| VBM | Maximum applied body bias in VTHO | −3.0 V | Yes | — |
| | calculation | | | |
| DVT0 | First coefficient of short-channel effect | 2.2 | Yes | — |
| | on Vₜₕ | | | |
| DVT1 | Second coefficient of short-channel | 0.53 | Yes | — |
| | effect on ^{V}th | | | |
| DVT2 | Body-bias coefficient of short-channel | −0.032 V ⁻¹ | Yes | — |
| | effect on Vth | | | |
| DVTPO | First coefficient of drain-induced Vₜₕ | 0.0 m | Yes | Not |
| | shift due to for long-channel pocket | | | modeled |
| | binned devices | | | if |
| | | | | binned |
| | | | | DVTPO |
| | | | | <=0.0 |
| DVTP1 | First coefficient of drain-induced Vth | 0.0 V⁻¹ | Yes | — |
| | chist due to for long-channel pocket | | | |
| | devices | | | |

Basic Model Parameters

| | | | | |
|---|---|---|---|---|
| DVT0W | First coefficient of narrow width effect | 0.0 | Yes | — |
| | on Vₜₕ for small channel length | | | |
| DVT1W | Second coefficient of narrow width | 5.3e6m⁻¹ | Yes | — |
| | effect on Vₜₕ for small channel length | | | |
| DVT2W | Body-bias coefficient of narrow width | −0.032 V⁻¹ | Yes | |
| | effect for small channel length | | | |
| U0 | Low-field mobility | 0.067 | Yes | — |
| | | m²/(Vs) | | |
| | | (NMOS); | | |
| | | 0.025 | | |
| | | m²/(Vs) | | |
| | | PMOS | | |
| UA | Coefficient of first-order mobility | 1.0e−9 m/V | Yes | — |
| | degradation due to vertical field for | MOBMOD = | | |
| | | | 0 and 1; | |
| | | 1.0e−15 m/V | | |
| | | for | | |
| | MOBMOD = 2 | | | |
| UB | Coefficient of secon-order mobility | 1.0e−19 m²/V² | Yes | — |
| | degradation due to vertical field | | | |
| UC | Coefficient of mobility degradation | −0.0465 V⁻¹ | Yes | — |
| | | due to body- | | |
| | | bias effect | | |
| | | for MOB- | | |
| | | MOD = 1; | | |
| | | −0.0465e−9 | | |
| | | m/V² for | | |
| | | MOBMOD = | | |
| | | 0 and 2 | | |
| EU | Exponent for mobility degradation of | 1.67 | | — |
| | MOBMOD = 2 | (NMOS); | | |
| | | 1.0 | | |
| | | (PMOS) | | |
| VSAT | Saturation velocity | 8.0e4m/s | Yes | — |
| A0 | Coefficient of channel-length | 1.0 | Yes | — |
| | dependence of bulk charge effect | | | |
| AGS | Coefficient of V_{gs} dependence of bulk | 0.0 V⁻¹ | Yes | — |
| | charge effect | | | |
| B0 | Bulk charge effect coefficient for | 0.0 m | Yes | — |
| | channel width | | | |
| B1 | Bulk charge effect width offset | 0.0 m | Yes | — |
| KETA | Body-bias coefficient of bulk charge | —0.047 V⁻¹ | Yes | — |
| | effect | | | |
| A1 | First non-saturation effect parameter | 0.0 V⁻¹ | Yes | |
| A2 | Second non-saturation factor | 1.0 | Yes | — |
| WINT | Channel-width offset parameter | 0.0 m | No | — |
| LINT | Channel-length offset parameter | 0.0 m | No | — |
| DWG | Coefficient of gate bias dependence of | 0.0 m/V | Yes | — |
| | W_{eff} | | | |
| DWB | Coefficient of body bias dependence of | 0.0 m/V^{1/2} | Yes | — |
| | W_{eff} | | | |
| VOFF | Offset voltage in subtbreshold | −0.08 V | Yes | — |
| | region for large W and L | | | |
| VOFFL | Channel-length dependence of VOFF | 0.0 mV | No | — |
| MINV | V_{gsteff} fitting parameter for moderate | 0.0 | Yes | — |
| | inversion condition | | | |
| NFACTOR | Subthreshold swing factor | 1.0 | Yes | — |
| ETA0 | DIBL coefficient in subthreshold region | 0.08 | Yes | — |
| ETAB | Body-bias coefficient for the | −0.07 V⁻¹ | Yes | — |
| | subthreshold DTBL effect | | | |
| DSUB | DIBL coefficient exponent in | DROUT | Yes | — |
| | subthreshold region | | | |
| CIT | Interface trap capacitance | 0.0 F/m² | Yes | — |
| CDSC | coupling capacitance between | 2.4e−4F/m² | Yes | — |
| | source/drain and channel | | | |
| CDSCB | Body-bias sensitivity of Cdsc | 0.0F/(Vm²) | Yes | — |
| CDSCD | Drain-bias sensitivity of CDSC | 0.0(F/Vm²) | Yes | — |
| PCLM | Channel length modulation parameter | 1.3 | Yes | — |
| PDIBLC1 | Parameter for DIBL effect on Rout | 0.39 | Yes | — |
| PDIBLC2 | Parameter for DIBL effect on Rout | 0.0086 | Yes | — |
| PDIBLCB | Body bias coefficient of DIBL effect on | 0.0V⁻¹ | Yes | — |
| | Rout | | | |
| DROUT | Channel-length dependence of DIBL | 0.56 | Yes | — |
| | effect on Rout | | | |
| PSCBE1 | First substrate current induced body- | 4.24e8Vm | Yes | — |
| | effect parameter | | | |
| PSCBE2 | Second substrate current induced body- | 1.0e−5m/V | Yes | — |
| | effect parameter | | | |
| PVAG | Gate-bias dependence of Early voltage | 0.0 | Yes | — |
| DELTA | Parameter for DC V_{dseff} | 0.01V | Yes | — |
| (δ in | | | | |
| equation) | | | | |
| FPROUT | Effect of pocket implant on Rout | 0.0 V/m^{0.5} | Yes | Not |
| | degradation | | | modeled |
| | | | | if binned |
| | | | | FPROUT |
| | | | not | |
| | | | | positive |
| PDITS | Impact of drain-induced Vₜₕ shift on | 0.0 V⁻¹ | Yes | Not modeled |
| | Rout | | | if Rout |
| | | | | binned |
| | | | | PDITS = |
| | | | | 0; |
| | | | | Fatal |
| | | | | error if |
| | | | | binned |
| | | | | PDITS |
| | | | | negative |
| PDITSL | Channel-length dependence of drain- | 0.0 m⁻ | No | Fatal |
| | induced Vₜₕ shift for Rout | | | error if |
| | | | | PDITSL |
| | | | | negative |
| PDITSD | V_{ds} dependence of drain-induced Vₜₕ | | Yes | — |
| | shift for Rout | | | |

A.4 Parameters for Asymmetric and Bias-Dependent R_{ds} Model

| | | | | |
|---|---|---|---|---|
| RDSW | Zero bias LDD resistance per unit width | 200.0 | Yes | If |
| | for RDSMOD = 0 | ohm | | negative, |
| | | (μm)^{WR} | | reset to |
| | | | | 0.0 |
| RDSWMIN | LDD resistance per unit width at | 0.0 | No | — |
| | high V_{gs} and zero V_{bs} | ohm | | |
| | for RDSMOD = 0 | (μm)^{WR} | | |
| RDW | Zero bias lightly-doped drain resistance | 100.0 | Yes | — |
| | R_{d}(V) per unit width for RDS-MOD = 1 | ohm | | |
| | | (μm)^{WR} | | |
| RDWMIN | Lightly-doped drain resistance per unit | 0.0 | No | — |
| | width at high V_{gs} and zero V_{bs} for | ohm | | |
| | RDSMOD = 1 | (μm)^{WR} | | |
| RSW | Zero bias lightly-doped source | 100.0 | Yes | — |
| | resistance Rₛ(V) per unit | ohm | | |
| | width for RDS-MOD = 1 | (μm)^{WR} | | |
| RSWMIN | Lightly-doped source resistance per unit | 0.0 | No | — |
| | width at high V_{gs} and zero V_{bs} for | | | |
| | RDSMOD = 1 | | | |
| PRWG | Gate-bias dependence of LDD | 1.0 V⁻¹ | Yes | — |
| | resistance | | | |
| PRWB | Body-bias dependence of LDD | 0.0 V^{-0.5} | Yes | — |
| | resistance | | | |
| WR | Channel-width dependence parameter of | 1.0 | Yes | — |
| | LDD resistance | | | |
| NRS | Number of source diffusion square | 1.0 | No | — |
| (instance | | | | |
| parameter | | | | |
| only) | | | | |
| NRD | Number of drain diffusion squares | 1.0 | No | — |
| (instance | | | | |
| parameter | | | | |
| only) | | | | |
| ALPHA0 | First parameter of impact ionization | 0.0 Am/V | Yes | — |
| | current | | | |
| ALPHA1 | Isub parameter for length scaling | 0.0 A/V | Yes | — |
| BETA0 | The second parameter of impact | 30.0 V | Yes | — |
| | ionization current | | | |

A.6 Gate-Induced Drain Leakage Model Parameters

| | | | | |
|---|---|---|---|---|
| AGIDL | Pre-exponential coefficient for GLDL | 0.0 mho | Yes | I_{gidl} = 0.0 |
| | | | | if binned |
| | | | | AGIDL = |
| | | | | 0.0 |
| BGIDL | Exponential coefficient for GIDL | 2.3e9 V/m Yes | I_{gidl} = 0.0 | |
| | | | | if binned |
| | | | | BGIDL = |
| | | | | 0.0 |
| CGIDL | Paramter for body-bias effect on GIDL | 0.5 V³ | Yes | — |
| DGIDL | Fitting parameter for band bending for | 0.8 V | Yes | — |
| | GIDL | | | |

A.7 Gate Dielectric Tunneling Current Model Parameters

| | | | | |
|---|---|---|---|---|
| AIGBACC | Parameter for I_{gb} in accumulation | 0.43 | Yes | — |
| | | (Fs²/g)^{0.5}m⁻¹ | | |
| BIGBACC | Parameter for I_{gb} in accumulation | 0.054 | Yes | — |
| | | (Fs²/g)^{0.5} | | |
| | | m⁻¹V⁻¹ | | |
| CIGBACC | Parameter for I_{gb} in accumulation | 0.075 V⁻¹ | Yes | — |
| NIGBACC | Parameter for I_{gb} in accumulation | 1.0 | Yes | Fatal error |
| | | if binned | | |
| | | value not | | |
| | | positive | | |
| AIGBINV | Parameter for I_{gb} in inversion | 0.35 | Yes | — |
| | | (Fs²/g)^{0.5}m⁻¹ | | |
| BIGBINV | Parameter for I_{gb} in inversion | 0.03 | Yes | — |
| | | (Fs²/g)^{0.5} | | |
| CIGBINV | Parameter for I_{gb} in inversion | 0.006 V⁻¹ | Yes | — |
| EIGBINV | Parameter for I_{gb} in inversion | 1.1 V | Yes | — |
| NIGBINV | Parameter for I_{gb} in inversion | 3.0 | Yes | Fatal error |
| | | | | if binned |
| | | | | value not |
| | | | | positive |
| AIGC | Parameter for I_{gcs} and I_{gcd} | 0.054 | Yes | — |
| | | (NMOS) and | | |
| | | 0.31 | | |
| | | (PMOS) | | |
| | | (Fs²/g)^{0.5}m⁻¹ | | |
| BIGC | Parameter for I_{gcs} and I_{gcd} | 0.054 | Yes | — |
| | | (NMOS) and | | |
| | | 0.024 | | |
| | | (PMOS) | | |
| | | (Fs²/g)^{0.5} | | |
| | | m⁻¹V⁻¹ | | |
| CIGG | Parameter for I_{gcs} and I_{gcd} | 0.075 | Yes | — |
| | | (NMOS) and | | |
| | | 0.03 | | |
| | | (PMOS) V⁻¹ | | |
| AIGSD | Parameter for I_{gs} and I_{gd} | 0.43 | Yes | — |
| | | (NMOS) and | | |
| | | 0.31 | | |
| | | (PMOS) | | |
| | | (Fs²/g)^{0.5}m⁻¹ | | |
| BIGSD | Parameter for I_{gs} and I_{gd} | 0.054 | Yes | — |
| | | (NMOS) and | | |
| | | 0.024 | | |
| | | (PMOS) | | |
| | | (Fs²/g)^{0.5} | | |
| | | m⁻¹V⁻¹ | | |
| CIGSD | Parameter for I_{gs} and I_{gd} | 0.075 | Yes | — |
| | | (NMOS) and | | |
| | | 0.03 | | |
| | | (PMOS) V⁻¹ | | |
| DLCIG | Source/drain overlap length for I_{gs} | LINT | Yes | — |
| | and I_{gd} | | | |
| NIGC | Parameter for I_{gcs}, I_{gcd}, I_{gs} and I_{gd} | 1.0 | Yes | Fatal error |
| | | | | if binned |
| | | | | value not |
| | | | | positive |
| POXEDGE | Factor for the gate oxide thickness in | 1.0 | Yes | Fatal error |
| | source/drain overlap regions | | | if binned |
| | | | | value not |
| | | | | positive |
| PIGCD | V_{ds} dependence of I_{gcs} and I_{gcd} | 1.0 | Yes | Fatal error |
| | | | | if binned |
| | | | | value not |
| | | | | positive |
| NTOX | Exponent for the gate oxide ratio | 1.0 | Yes | — |
| TOXREF | Nominal gate oxide thickness for gate | 3.0e−9m | No | Fatal error |
| | dielectric tunneling current model | | | if not positive |
| | only | | | |

A.8 Charge and Capacitance Model Parameters

| | | | | |
|---|---|---|---|---|
| XPART | Charge partition parameter | 0.0 | No | — |
| CGSO | Non LDD region source-gate overlap | calculated | No | Note-6 |
| | capacitance per unit channel width | (F/m) | | |
| CGDO | Non LDD region drain-gate overlap | calculated | No | Note-6 |
| | capacitance per unit channel width | (F/m) | | |
| CGBO | Gate-bulk overlap capacitance per | 0.0 | F/m | Note-6 |
| | unit channel length | | | |
| CGSL | Overlap capacitance between gate and | 0.0 F/m | Yes | — |
| | lightly-doped source region | | | |
| CGDL | Overlap capacitance between gate and | 0.0 F/m | Yes | — |
| | lightly-doped source region | | | |
| CKAPPAS | Coefficient of bias-dependent overlap | 0.6 V | Yes | — |
| | capacitance for the source side | | | |
| CKAPPAD | Coefficient of bias-dependent overlap | CKAPPAS | Yes | — |
| | capacitance for the drain side | | | |
| CF | Fringing field capacitance | calculated | Yes | Note-7 |
| | | (F/m) | | |
| CLC | Constant term for the short channel | 1.0e−7m | Yes | — |
| | model | | | |
| CLE | Exponential term for the short channel | 0.6 | Yes | — |
| | model | | | |
| DLC | Channel-length offset parameter for | LINT (m) | No | — |
| | CV model | | | |
| DWC | Channel-width offset parameter for | WINT (m) | No | — |
| | CV model | | | |
| VFBCV | Flat-band voltage parameter (for | —1.0 V | Yes | — |
| | CAPMOD = 0 only) | | | |
| NOFF | CV parameter in V_{gsteff,CV} for weak to | 1.0 | Yes | — |
| | strong inversion | | | |
| VOFFCV | CV parameter in V_{gsteff,CV} for week to | 0.0 V | Yes | — |
| | strong inversion | | | |
| ACDE | Exponential coefficient for charge | 1.0 m/V | Yes | — |
| | thickness in CAPMOD = 2 for accumu- | | | |
| | lation and depletion regions | | | |
| MOIN | Coefficient for the gate-bias depen- | 15.0 | Yes | — |
| | dent surface potential | | | |

A.9 High-Speed/RF Model Parameters

| | | | | |
|---|---|---|---|---|
| XRCRG1 | Parameter for distributed channel- | 12.0 | Yes | Warning |
| | resistance effect for both intrinsic- | | | message |
| | input resistance and charge-deficit | | | issued if |
| | NQS models | | | binned |
| | | | | XRCRG1 |
| | | | <=0.0 | |
| XRCRG2 | Parameter to account for the excess | 1.0 | Yes | — |
| | channel diffusion resistance for both | | | |
| | intrinsic input resistance and charge- | | | |
| | deficit NQS models | | | |
| RBPB | Resistance connected between | 50.0 ohm | No | If less than |
| (Also an | bNodePrime and bNode | | | 1.0e−3ohm, |
| instance | | | | reset to |
| parameter) | | | | 1.0e−3ohm |
| RBPD | Resistance connected between | 50.0 ohm | No | If less than |
| (Also an | bNodePrime and dbNode | | | 1.0e−3ohm, |
| instance | | | | reset to |
| parameter) | | | | 1.0e−3ohm |
| RBPS | Resistance connected between | 50.0 ohm | No | If less than |
| (Also an | bNodePrime and sbNode | | | 1.0e−3ohm, |
| instance | | | | reset to |
| parameter) | | | | 1.0e−3ohm |
| RBDB | Resistance connected between | 50.0 ohm | No | If less than |
| (Also an | dbNode and bNode | | | 1.0e−3ohm, |
| instance | | | reset to | |
| parameter) | | | | 1.0e−3ohm |
| RBSB | Resistance connected between | 50.0 ohm | No | If less than |
| (Also an | sbNode and bNode | | | 1.0e−3ohm, |
| instance | | | reset to | |
| parameter) | | | | 1.0e−3ohm |
| GBMIN | Conductance in parallel with each of | 1.0e−12mho | No | Warning |
| | the five substrate resistances to avoid | | | message |
| | potential numerical instability due to | | | issued if |
| | unreasonably too large a substrate | | | less than |
| | resistance | | | 1.0e−20 |
| | | | | mho |

A.10 Flicker and Thermal Noise Model Parameters

| | | | | |
|---|---|---|---|---|
| NOIA | Flicker noise parameter A | 6.25e41 | No | — |
| | | (eV)⁻¹s^{1-EF}m⁻³ | | |
| | | for NMOS; | | |
| | | 6.188e40 | | |
| | | (eV)⁻¹s^{1-EF}m⁻³ | | |
| | | for PMOS | | |
| NOIB | Flicker noise parameter B | 3.125e26 | No | — |
| | | (eV)⁻¹s^{1-EF}m⁻¹ | | |
| | | for NMOS; | | |
| | | 1.5e25 | | |
| | | (eV)⁻¹s^{1-EF}m⁻¹ | | |
| | | for PMOS | | |
| NOIC | Flicker noise parameter C | 8.75 | No | — |
| | | (eV)⁻¹s^{1-EF}m | | |
| EM | Saturation field | 4.1e7V/m | No | — |
| AF | Flicker noise exponent | 1.0 | No | — |
| EF | Flicker noise frequency exponent | 1.0 | No | — |
| KY | Flicker noise coefficient | 0.0 | No | — |
| | | A^{2-EF}s^{1-EF}F | | |
| NTNOI | Noise factor for short-channel devices | 1.0 | No | − |
| | for TNOIMOD = 0 only | | | |
| TNOIA | Coefficient of channel-length depen- | 1.5 | No | — |
| | dence of total channel thermal noise | | | |
| TNOIB | Channel-length dependence parameter | 3.5 | No | — |
| | for channel thermal noise partitioning | | | |

A.11 Layout-Dependent Parasitics Model Parameters

| | | | | |
|---|---|---|---|---|
| DMCG | Distance from S/D contact center to | 0.0 m | No | — |
| | the gate edge | | | |
| DMCI | Distance from S/D contact center to | DMCG | No | — |
| | the isolation edge in the channel- | | | |
| | length direction | | | |
| DMDG | Same as DMCG but for merged | 0.0 m | No | — |
| | device only | | | |
| DMCGT | DMCG of test structures | 0.0 m | No | — |
| NF | Number of device fingers | 1 | No | Fatal error |
| (instance | | | | if less than |
| parameter | | | | one |
| only) | | | | |
| DWJ | Offset of the S/D junction width | DWC (in | No | — |
| | | CVmodel) | | |
| MIN | Whether to minimize the number of | 0 | No | — |
| (instance | drain or source diffusions for even- | (minimize | | |
| parameter | number fingered device | the drain dif- | | |
| only) | | fusion number) | | |
| XGW | Distance from the gate contact to the | 0.0 m | No | — |
| | channel edge | | | |
| XGL | Offset of the gate length due to varia- | 0.0 m | No | — |
| | tions in patterning | | | |
| XL | Channel length offset due to mask/ | 0.0 m | No | — |
| | etch effect | | | |
| XW | Channel width offset due to mask/etch | 0.0 m | No | — |
| | effect | | | |
| NGCON | Number of gate contacts | 1 | No | Fatal error |
| | | | | if less than |
| | | | | one; if not |
| | | | | equal to I |
| | | | | or 2, warn- |
| | | | | ing mes- |
| | | | | sage issued |
| | | | | and reset to 1 |

A.12 Asymmetric Source/Drain Junction Diode Model Parameters

| | | | | |
|---|---|---|---|---|
| (separate for | | | | |
| source and drain | | | | |
| side as indicated | | | | |
| in the names) | | | | |
| IJTHSREV | Limiting current in reverse bias region | IJTHSREV = | No | If not posi- |
| IJTHDREV | | 0.1 A | | tive, reset |
| | | IJTHDREV = | | to 0.1 A |
| | | IJTHSREV | | |
| IJTHSFWD | Limiting current in forward bias | IJTHSFWD = | No | If not posi- |
| IJTHDFWD | region | 0.1 A | | tive, reset |
| | | IJTHDFWD = | | |
| | | IJTHSFWD | | |
| XJBVS | Fitting parameter for diode break- | XJBVS = 1.0 | No | Note-8 |
| XJBVD | down | XJBVD = | | |
| | | XJBVS | | |
| BVS | Breakdown voltage | BVS = 10.0 V | No | If not posi |
| BVD | | BVD = BVS | | tive, reset |
| | | | | to 10.0 V |
| JSS | Bottom junction reverse saturation | JSS = | No | — |
| JSD | current density | 1.0e−4 A/m² | | |
| | | JSD = JSS | | |
| JSWS | Isolation-edge sidewall reverse satura- | JSWS = | No | — |
| JSWD | tion current density | 0.0 A/m | | |
| | | JSWD = | | |
| | | JSWS | | |
| JSWGS | Gate-edge sidewall reverse saturation | JSWGS = | No | — |
| JSWGD | current density | 0.0 A/m | | |
| | | JSWGD = | | |
| | | JSWGS | | |
| CJS | Bottom junction capacitance per unit | CJS = 5.0e−4 | No | — |
| CJD | area at zero bias | F/m² | | |
| | | CJD = CJS | | |
| MJS | Bottom junction capacitance grating | MJS = 0.5 | No | — |
| MID | coefficient | MJD = MJS | | |
| MJSWS | Isolation-edge sidewall junction | MJSWS = | No | — |
| MJSWD | capacitance grading coefficient | 0.33 | | |
| | | MJSWD = | | |
| | | MJSWS | | |
| CJSWS | Isolation-edge sidewall junction | CJSWS = | No | — |
| CJSWD | capacitance per unit area | 5.0e−10 | | |
| | | F/m | | |
| | | CJSWD = | | |
| | | CJSWS | | |
| CJSWGS | Gate-edge sidewall junction capaci- | CJSWGS = | No | — |
| CJSWGD | tance per unit length | CJSWS | | |
| | | CJSWGD = | | |
| | | CJSWS | | |
| MISWGS | Gate-edge sidewall junction capaci- | MJSWGS = | No | — |
| MJSWGD | tance grading coefficient | MJSWS | | |
| | | MJSWGD = | | |
| | | MJSWS | | |
| PB | Bottom junction bnilt-in potential | PBS = 1.0 V | No | — |
| | | PBD = PBS | | |
| PBSWS | Isolation-edge sidewall junction built- | PBSWS = | No | — |
| PBSWD | in potential | 1.0 V | | |
| | | PBSWD = | | |
| | | PBSWS | | |
| PBSWGS | Gate-edge sidewall junction built-in | PBSWGS = | No | — |
| PBSWGD | potential | PBSWS | | |
| | | PBSWGD = | | |
| | | PBSWS | | |

A.13 Temperature Dependence Parameters

| | | | | |
|---|---|---|---|---|
| TNOM | Temperature at which parameters are | 27° C. | No | — |
| | extracted | | | |
| UTE | Mobility temperature exponent | −1.5 | Yes | — |
| KT1 | Temperature coefficient for threshold | −0.11 V | Yes | — |
| | voltage | | | |
| KT1L | Channel length dependence of the | 0.0 Vm | Yes | — |
| | temperature coefficient for threshold | | | |
| | voltage | | | |
| KT2 | Body-bias coefficient of Vth tempera- | 0.022 | Yes | — |
| | ture effect | | | |
| UA1 | Temperature coefficient for UA | 1.0e−9m/V | Yes | — |
| UBI | Temperature coefficient for UB | −1.Oe−18 | Yes | — |
| | | (m/V)² | | |
| UC1 | Temperature coefficient for UC | 0.067 V⁻¹ for | Yes | — |
| | | MOBMOD = 1; | | |
| | | 0.025 m/V² | | |
| | | for MOBMOD = | | |
| | | 0 and 2 | | |
| AT | Temperature coefficient for satura- | 3.3e4m/s | Yes | — |
| | tion velocity | | | |
| PRT | Temperature coefficient for Rdsw | 0.0 ohm-m | Yes | — |
| NIS, NJD | Emission coefficients of junction for | NJS = 1.0; | No | — |
| | source and drain junctions, respec- | NJD = NJS | | |
| | tively | | | |
| XTIS, XTID | Junction current temperature expo- | XTIS = 3.0; | No | — |
| | nents for source and drain junctions, | XTID = XTIS | | |
| | respectively | | | |
| TPB | Temperature coefficient of PB | 0.0 V/K | No | — |
| TPBSW | Temperature coefficient of PBSW | 0.0 V/K | No | — |
| TPBSWG | Temperature coefficient of PBSWG | 0.0 V/K | No | — |
| TCJ | Temperature coefficient of CJ | 0.0 K⁻¹ | No | — |
| TCJSW | Temperature coefficient of CJSW | 0.0 K⁻¹ | No | — |
| TCJSWG | Temperature coefficient of CJSWG | 0.0 K⁻¹ | No | — |

A.14 dW and dL Parameters

| | | | | |
|---|---|---|---|---|
| WL | Coefficient of length dependence for | 0.0 m^{WLN} | No | — |
| | width offset | | | |
| WLN | Power of length dependence of width | 1.0 | No | — |
| | offset | | | |
| WW | Coefficient of width dependence for | 0.0 m^{WWN} | No | — |
| | width offset | | | |
| WWN | Power of width dependence of width | 1.0 | No | — |
| | offset | | | |
| WWL | Coefficient of length and width cross | 0.0 | No | — |
| | term dependence for width offset | m^{WWN+WLN} | | |
| LL | Coefficient of length dependence for | 0.0 m^{LLN} | No | — |
| | length offset | | | |
| LLN | Power of length dependence for | 1.0 | No | — |
| | length offset | | | |
| LW | Coefficient of width dependence for | 0.0 m^{LWN} | No | — |
| | length offset | | | |
| LWN | Power of width dependence for length | 1.0 | No | — |
| | offset | | | |
| LWL | Coefficient of length and width cross | 0.0 | No | — |
| | term dependence for length offset | m^{LWN+LLN} | | |
| LLC | Coefficient of length dependence for | LL | No | — |
| | CV channel length offset | | | |
| LWC | Coefficient of width dependence for | LW | No | — |
| | CV channel length offset | | | |
| LWLC | Coefficient of length and width cross- | LWL | No | — |
| | term dependence for CV channel | | | |
| | length offset | | | |
| WLC | Coefficient of length dependence for | WL | No | — |
| | CV channel width offset | | | |
| WWC | Coefficient of width dependence for | WW | No | — |
| | CV channel width offset | | | |
| WWLC | Coefficient of length and width cross- | WWL | No | — |
| | term dependence for CV channel | | | |
| | width offset | | | |

NOTES:
Note-1:
If γ₁ is not given, it is calculated by
${γ}_{1} = \frac{\sqrt{2 q {ɛ}_{si} NDEP}}{{C}_{oxe}}$
If γ₂ is not given, it is calculated by
${γ}_{2} = \frac{\sqrt{2 q {ɛ}_{si} NSUB}}{{C}_{oxe}}$
Note-2:
If NDEP is not given and γ₁ is given, NDEP is calculated from
$NDEP = \frac{{γ}_{1}^{2} {C}_{oxe}^{2}}{2 q {ɛ}_{si}}$
If both γ₁ and NDEP are not given, NDEP defaults to 1.7e17 cm⁻³
and γ₁ is calculated from NDEP.
Note-3:
If VBX is not given, it is calculated by
$\frac{qNDEP \cdot {XT}^{2}}{2 {ɛ}_{si}} = {Φ}_{s} - VBX$
Note-4:
If VTH0 is not given, it is calculated by
$VTH0 = VFB + {Φ}_{s} + K1 \sqrt{{Φ}_{s} - {V}_{bs}}$
where VFB = −1.0. If VTH0 is given, VFB defaults to
$VFB = VTH0 - {Φ}_{s} - K1 \sqrt{{Φ}_{s} - {V}_{bs}}$
Note-5:
If K₁ and K₂ are not given, they are calculated by
$\begin{matrix}K1 = {γ}_{2} - 2 K2 \sqrt{{Φ}_{s} - VBM} \\ K2 = \frac{( {γ}_{1} - {γ}_{2} ) ( \sqrt{{Φ}_{s} - VBX} - \sqrt{{Φ}_{s}} )}{2 \sqrt{{Φ}_{s}} ( \sqrt{{Φ}_{s} - VBM} - \sqrt{{Φ}_{s}} ) + VBM}\end{matrix}$
Note-6:
If CGSO is not given, it is calculated by
If(DLC is given and > 0.0)
CGSO = DLC · Cₒₓₑ − CGSL
if (CGSO < 0.0), CGSO = 0.0
Else
CGSO = 0.6 · XJ · Cₒₓₑ
If CGDO is not given, it is calculated by
If(DLC is given and > 0.0)
CGDO = DLC · Cₒₓₑ − CGDL
if(CGDO < 0.0), CGDO = 0.0
Else
CGDO = 0.6 · XJ · Cₒₓₑ
If CGBO is not given, it is calculated by
CGBO = 2 · DWC · Cₒₓₑ
Note-7:
If CF is not given, it is calculated by
$CF = \frac{2 \cdot EPSROX \cdot {ɛ}_{0}}{π} \cdot log ( 1 + \frac{4.0 e - 7}{TOXE} )$
Note-8:
For dioMod = 0, if XJBVS < 0.0, it is reset to 1.0.
For dioMod = 2, if XJBVS <= 0.0, it is reset to 1.0.
For dioMod = 0, if XJBVD < 0.0, it is reset to 1.0.
For dioMod = 2, if XJBVD <= 0.0, it is reset to 1.0.

Poly Silicon Gate Depletion

$$\begin{matrix}{V}_{poly} = 0.5 {X}_{poly} {E}_{poly} = \frac{qNGATE \cdot {X}_{poly}^{2}}{2 {ɛ}_{si}} & ( 1.2 .1 ) \\ EPSROX \cdot {E}_{ox} = {ɛ}_{si} {E}_{poly} = \sqrt{2 q {ɛ}_{si} NGATE \cdot {V}_{poly}} & ( 1.2 .2 ) \\ {V}_{gs} - {V}_{FB} - {Φ}_{s} = {V}_{poly} + {V}_{ox} & ( 1.2 .3 ) \\ {a ( {V}_{gs} - {V}_{FB} - {Φ}_{s} - {V}_{poly} )}^{2} - {V}_{poly} = 0 & ( 1.2 .4 )\end{matrix}$$

V_{gs}−V_{FB}−Φₛ=V_{poly}Vₒₓ (1.2.3)
a(V_{gs}−V_{FB}−Φₛ−V_{poly})²V_{poly}=0 (1.2.4)
where

$$\begin{matrix}a = \frac{{EPSROX}^{2}}{2 q {ɛ}_{si} NGATE \cdot {TOXE}^{2}} & ( 1.2 .5 ) \\ {V}_{gse} = VFB + {Φ}_{s} + \frac{q {ɛ}_{si} NGATE \cdot {TOXE}^{2}}{{EPSROX}^{2}} & ( 1.2 .6 ) \\ ( \sqrt{1 + \frac{2 {EPSROX}^{2} ( {V}_{gs} - VFB - {Φ}_{s} )}{q {ɛ}_{si} NGATE \cdot {TOXE}^{2}}} - 1 ) & \end{matrix}$$

Effective Channel Length and Width

$$\begin{matrix}{L}_{eff} = {L}_{drawn} + XL - 2 d L & ( 1.3 .1 ) \\ {W}_{eff} = \frac{{W}_{drawn}}{NF} + XW - 2 dW & ( 1.3 .2 a ) \\ {W}_{eff}^{′} = \frac{{W}_{drawn}}{NF} + XW - 2 {dW}^{′} & ( 1.3 .2 b ) \\ dW = {dW}^{′} + DWG \cdot {V}_{gsteff} + DWB ( \sqrt{{Φ}_{s} - {V}_{bseff}} - \sqrt{{Φ}_{s}} ) & ( 1.3 .3 ) \\ {dW}^{′} = WINT + \frac{WL}{{L}^{WLN}} + \frac{WW}{{W}^{WWN}} + \frac{WWL}{{L}^{WLN} {W}^{WWN}} & \\ dL = LINT + \frac{LL}{{L}^{LLN}} + \frac{LW}{{W}^{LWN}} + \frac{LWL}{{L}^{LLN} {W}^{LWN}} & ( 1.3 .4 ) \\ {L}_{active} = {L}_{drawn} + XL - 2 dL & ( 1.3 .5 ) \\ {W}_{active} = \frac{{W}_{drawn}}{NF} + XW - 2 dW & ( 1.3 .6 ) \\ dL = DLC + \frac{LLC}{{L}^{LLN}} + \frac{LWC}{{W}^{LWN}} + \frac{LWLC}{{L}^{LLN} {W}^{LWN}} & ( 1.3 .7 ) \\ dW = DWC + \frac{WLC}{{L}^{WLN}} + \frac{WWC}{{W}^{WWN}} + \frac{WWLC}{{L}^{WLN} {W}^{WWN}} & ( 1.3 .8 ) \\ {W}_{effcj} = \frac{{W}_{drawn}}{NF} - & ( 1.3 .9 ) \\ 2 \cdot ( DWJ + \frac{WLC}{{L}^{WLN}} + \frac{WWC}{{W}^{WWN}} + \frac{WWLC}{{L}^{WLN} {W}^{WWN}} ) & \end{matrix}$$

Long Channel Model with Uniform Doping

$$\begin{matrix}{V}_{th} = VFB + {Φ}_{s} + γ \sqrt{{Φ}_{s} - {V}_{bs}} & ( 2.1 .1 ) \\ = VTH0 + γ ( \sqrt{{Φ}_{s} - {V}_{bs}} - \sqrt{{Φ}_{s}} ) & \\ γ = \frac{\sqrt{2 q {ɛ}_{si} {N}_{substrate}}}{{C}_{oxe}} & ( 2.1 .2 )\end{matrix}$$

Long Channel Model with Non-Uniform Doping

$$\begin{matrix}{V}_{th} = {V}_{th , NDEP} + \frac{{qD}_{0}}{{C}_{oxe}} + \\ {K1}_{NDEP} ( \sqrt{{φ}_{s} - {V}_{bs} - \frac{{qD}_{1}}{{ɛ}_{si}}} - \sqrt{{φ}_{s} - {V}_{bs}} )\end{matrix} \qquad ( 2.2 .1 )$$

where K1_{NDEP} is the body-bias coefficient for N_{substrate}=NDEP,
V_{th,NDEP}=VTH0+K1_{NDEP}(\sqrt{φₛ−V_{bs}}−\sqrt{φₛ}) (2.2.2)
with a definition of

$$\begin{matrix}{ψ}_{s} = 0.4 + \frac{{k}_{B} T}{q} ln ( \frac{NDEP}{{n}_{i}} ) & ( 2.2 .3 ) \\ {D}_{0} = {D}_{00} + {D}_{01} = {\int }_{0}^{{X}_{dep} 0} ( N ( x ) - NDEP ) ⅆ x + {\int }_{{X}_{dep} 0}^{{X}_{dep}} ( N ( x ) - NDEP ) ⅆ x & ( 2.2 .4 ) \\ {D}_{1} = {D}_{10} + {D}_{11} = {\int }_{0}^{{X}_{dep} 0} ( N ( x ) - NDEP ) x ⅆ x + {\int }_{{x}_{dep} 0}^{{X}_{dep}} ( N ( x ) - NDEP ) x ⅆ x & ( 2.2 .5 ) \\ {V}_{th} = VTH 0 + K 1 ( \sqrt{{Φ}_{s} - {V}_{bs}} - \sqrt{{Φ}_{s}} ) - K 2 \cdot {V}_{bs} & ( 2.2 .6 )\end{matrix}$$

Vₜₕ=VTH0+K1(\sqrt{Φₛ−V_{bs}}−\sqrt{Φₛ})−K2·V_{bs} (2.2.6)
where K2=qC₀₁/Cₒₓₑ, and the surface potential is defined as

$${Φ}_{s} = 0.4 + \frac{{k}_{B} T}{q} ln ( \frac{NDEP}{{n}_{i}} ) + PHIN \qquad ( 2.2 .7 )$$

where
PHIN=−qD₁₀/εₛᵢ
K1=γ₂−2K2\sqrt{Φₛ−VBM} (2.2.8)

$$\begin{matrix}PHIN = - {qD}_{10} / {ɛ}_{si} & \\ K1 = {γ}_{2} - 2 K2 \sqrt{{Φ}_{s} - VBM} & ( 2.2 .8 ) \\ K2 = \frac{( {γ}_{1} - {γ}_{2} ) ( \sqrt{{Φ}_{s} - VBX} - \sqrt{{Φ}_{s}} )}{2 \sqrt{{Φ}_{s}} ( \sqrt{{Φ}_{s} - VBM} - \sqrt{{Φ}_{s}} ) + VBM} & ( 2.2 .9 ) \\ {γ}_{1} = \frac{\sqrt{2 q {ɛ}_{si} NDEP}}{{C}_{oxe} } & ( 2.2 .10 ) \\ {γ}_{2} = \frac{\sqrt{2 q {ɛ}_{si} NSUB}}{{C}_{oxe}} & ( 2.2 .11 ) \\ \frac{qNDEP \cdot {XT}^{2}}{2 {ɛ}_{si}} = {Φ}_{s} - VBX & ( 2.2 .12 )\end{matrix}$$

Non-Uniform Lateral Doping

$$\begin{matrix}\begin{matrix}{V}_{th} = VTH0 + K1 ( \sqrt{{Φ}_{s} - {V}_{bs}} - \sqrt{{Φ}_{s}} ) \cdot \sqrt{1 + \frac{LPEB}{{L}_{eff}}} - \\ K2 \cdot {V}_{bs} + K1 ( \sqrt{1 + \frac{LPE0}{{L}_{eff}}} - 1 ) \sqrt{{Φ}_{s}}\end{matrix} & ( 2.3 .1 ) \\ Δ {V}_{th} ( DITS ) = - {nv}_{t} \cdot ln ( \frac{( 1 - {ⅇ}^{- {V}_{ds} / {v}_{t}} ) \cdot {L}_{eff}}{{L}_{eff} + DVTP0 \cdot ( 1 + {ⅇ}^{- DVTP1 \cdot {V}_{ds}} )} ) & ( 2.3 .2 ) \\ Δ {V}_{th} ( DITS ) = - {nv}_{t} \cdot ln ( \frac{{L}_{eff}}{{L}_{eff} + DVTP0 \cdot ( 1 + {ⅇ}^{- DVTP1 \cdot {V}_{ds}} )} ) & ( 2.3 .3 )\end{matrix}$$

Short-Channel and DIBL Effect
ΔVₜₕ(SCE,DIBL)=−θₜₕ(L_{eff})·[2(V_{bi}−Φₛ)+V_{ds}] (2.4.1)

$$\begin{matrix}Δ {V}_{th} ( SCE , DIBL ) = - {θ}_{th} ( {L}_{eff} ) \cdot [ 2 ( {V}_{bi} - {Φ}_{s} ) + {V}_{ds} ] & ( 2.4 .1 ) \\ {V}_{bi} = \frac{{k}_{B} T}{q} ln ( \frac{NDEP \cdot NSD}{{n}_{i}^{2}} ) & ( 2.4 .2 ) \\ {θ}_{th} ( {L}_{eff} ) = \frac{0.5}{cosh ( \frac{{L}_{eff}}{{l}_{t}} ) - 1} & ( 2.4 .3 ) \\ {l}_{t} = \sqrt{\frac{{ɛ}_{si} \cdot TOXE \cdot {X}_{dep}}{EPSROX \cdot η}} & ( 2.4 .4 ) \\ {X}_{dep} = \sqrt{\frac{2 {ɛ}_{si} ( {Φ}_{s} - {V}_{bs} )}{qNDEP}} & ( 2.4 .5 ) \\ {θ}_{th} ( {L}_{eff} ) = exp ( - \frac{{L}_{eff}}{2 {l}_{t}} ) + 2 exp ( - \frac{{L}_{eff}}{{l}_{t}} ) & ( 2.4 .6 ) \\ {θ}_{th} ( SCE ) = \frac{0.5 \cdot DVT0}{cosh ( DVT1 \cdot \frac{{L}_{eff}}{{l}_{t}} ) - 1} & ( 2.4 .7 ) \\ Δ {V}_{th} ( SCE ) = - {θ}_{th} ( SCE ) \cdot ( {V}_{bi} - {Φ}_{s} ) & ( 2.4 .8 ) \\ {l}_{t} = \sqrt{\frac{{ɛ}_{si} \cdot TOXE \cdot {X}_{dep}}{EPSROX}} \cdot ( 1 + DVT2 \cdot {V}_{bs} ) & ( 2.4 .9 ) \\ {θ}_{th} ( DIBL ) = \frac{0.5}{cosh ( DSUB \cdot \frac{{L}_{eff}}{{l}_{t0}} ) - 1} & ( 2.4 .10 ) \\ {ΔV}_{th} ( DIBL ) = - {θ}_{th} ( DIBL ) \cdot ( ETA0 + ETAB \cdot {V}_{bs} ) \cdot {V}_{ds} & ( 2.4 .11 ) \\ {l}_{t0} = \sqrt{\frac{{ɛ}_{si} \cdot TOXE \cdot {X}_{dep0}}{EPSROX}} & ( 2.4 .12 ) \\ {X}_{dep0} = \sqrt{\frac{2 {ɛ}_{si} {Φ}_{s}}{qNDEP}} & ( 2.4 .13 )\end{matrix}$$

Narrow Width Effect

$$\begin{matrix}\frac{π qNDEP \cdot {X}_{dep , max}^{2}}{2 {C}_{axe} {W}_{eff}} = 3 π \frac{TOXE}{{W}_{eff}} {Φ}_{s} & ( 2.5 .1 ) \\ Δ {V}_{th} ( Narrow\_width1 ) = ( K3 + K3B \cdot {V}_{bs} ) \frac{TOXE}{{W}_{eff}^{′} + W0} {Φ}_{s} & ( 2.5 .2 ) \\ Δ {V}_{th} ( Narrow\_width2 ) = - \frac{0.5 \cdot DVT0W}{cosh ( DVT1W \cdot \frac{{L}_{eff} {W}_{eff}^{′}}{{l}_{tw}} ) - 1} \cdot \\ ( {V}_{bi} - {Φ}_{s} ) & ( 2.5 .3 ) \\ {l}_{tw} = \sqrt{\frac{{ɛ}_{si} \cdot TOXE \cdot {X}_{dep}}{EPSROX}} \cdot ( 1 + DVT2W \cdot {V}_{bs} ) & ( 2.5 .4 ) \\ \begin{matrix}{V}_{th} = VTH0 + \\ ( {K}_{1 ox} \cdot \sqrt{{Φ}_{s} - {V}_{bseff}} - K1 \cdot \sqrt{{Φ}_{s}} ) \sqrt{1 + \frac{LPEB}{{L}_{eff}}} - \\ {K}_{2 ox} {V}_{bseff} + {K}_{1 ox} ( \sqrt{1 + \frac{LPE0}{{L}_{eff}}} - 1 ) \sqrt{{Φ}_{s}} + \\ ( K3 + K3B \cdot {V}_{bseff} ) \frac{TOXE}{{W}_{eff}^{′} + W0} {Φ}_{s} - 0.5 \cdot \\ [ \frac{DVT0W}{cosh ( DVT1W \frac{{L}_{eff} {W}_{eff}^{′}}{{l}_{tw}} ) - 1} + \\ \frac{DVT0}{cosh ( DVT1 \frac{{L}_{eff}}{{l}_{t}} ) - 1} ] ( {V}_{bi} - {Φ}_{s} ) - \\ \frac{0.5}{cosh ( DSUB \frac{{L}_{eff}}{{l}_{t0}} ) - 1} ( ETA0 + ETAB \cdot {V}_{bseff} ) \cdot {V}_{ds}\end{matrix} & ( 2.5 .5 ) \\ {K}_{1 ox} = K1 \cdot \frac{TOXE}{TOXM} & ( 2.5 .6 ) \\ and & \\ {K}_{2 ox} = K2 \cdot \frac{TOXE}{TOXM} & ( 2.5 .7 ) \\ {V}_{bseff} = {V}_{bc} + 0.5 \cdot [ ( {V}_{bs} - {V}_{bc} - {δ}_{1} ) + \\ \sqrt{{( {V}_{bs} - {V}_{bc} - {δ}_{1} )}^{2} - 4 {δ}_{1} \cdot {V}_{bc}} ] & ( 2.5 .8 ) \\ {V}_{bc} = 0.9 ( {Φ}_{s} - \frac{{K1}^{2}}{4 {K2}^{2}} ) & ( 2.5 .9 )\end{matrix}$$

Channel Charge Model

$${Q}_{chsubs0} = \sqrt{\frac{{qNDEPɛ}_{si}}{2 {Φ}_{s}}} {v}_{t} \cdot exp ( \frac{{V}_{gse} - {V}_{th} - {Voff}^{′}}{{nv}_{t}} ) \qquad ( 3.1 .1 )$$

where

$$\begin{matrix}{Voff}^{′} = VOFF + \frac{VOFFL}{{L}_{eff}} & ( 3.1 .1 a ) \\ {Q}_{chs0} = {C}_{oxe} \cdot ( {V}_{gse} - {V}_{th} ) & ( 3.1 .2 ) \\ {Q}_{ch0} = {C}_{oxeff} \cdot {V}_{gsteff} & ( 3.1 .3 ) \\ {C}_{oxeff} = \frac{{C}_{oxe} \cdot {C}_{cen}}{{C}_{axe} + {C}_{cen}} with {C}_{cen} = \frac{{ɛ}_{xi}}{{X}_{DC}} & ( 3.1 .4 ) \\ {X}_{DC} = \frac{1.9 \times {10}^{- 9} cm}{1 + {( \frac{{V}_{gsteff} + 4 ( VTH0 - VFB - {Φ}_{s} )}{2 TOXP} )}^{0.7}} & ( 3.1 .5 ) \\ {V}_{gsteff} = \frac{{nv}_{t} ln \{ 1 + exp [ \frac{{m}^{*} ( {V}_{gse} - {V}_{th} )}{{nv}_{t}} ] \}}{{m}^{*} + {nC}_{oxe} \cdot \sqrt{\frac{2 {Φ}_{s}}{qNDEP {ɛ}_{si}}} exp [ - \frac{( 1 - {m}^{*} ) ( {V}_{gse} - {V}_{th} ) - {Voff}^{′}}{{nv}_{t}} ]} & ( 3.1 .6 a )\end{matrix}$$

where

$$\begin{matrix}m \text{*} = 0.5 + \frac{arctan ( MINV )}{π} & ( 3.1 .6 b ) \\ {Q}_{chs} ( y ) = {C}_{axeff} \cdot ( {V}_{gse} - {V}_{th} - {A}_{bulk} {V}_{F} ( y ) ) & ( 3.1 .7 ) \\ {Q}_{chs} ( y ) = {Q}_{chr0} + {ΔQ}_{chs} ( y ) & ( 3.1 .8 ) \\ {Q}_{chsubs} ( y ) = {Q}_{chsubs0} \cdot exp ( - \frac{{A}_{bulk} {V}_{F} ( y )}{{nv}_{i}} ) & ( 3.1 .9 ) \\ {Q}_{chsubs } ( y ) = {Q}_{chsubs0} ( 1 - \frac{{A}_{bulk} {V}_{F} ( y )}{{nv}_{i}} ) & ( 3.1 .10 ) \\ {Q}_{chsubs} ( y ) = {Q}_{chsubs0} + {ΔQ}_{chsubs} ( y ) & ( 3.1 .11 ) \\ {ΔQ}_{chsubs} ( y ) = - {Q}_{chsubs0} \cdot \frac{{A}_{bulk} {V}_{F} ( y )}{{nv}_{i}} & ( 3.1 .12 ) \\ {ΔQ}_{ch} ( y ) = \frac{{ΔQ}_{chs} ( y ) \cdot {ΔQ}_{chsubs} ( y )}{{ΔQ}_{chs} ( y ) + {ΔQ}_{chsubs} ( y )} & ( 3.1 .13 ) \\ {ΔQ}_{ch} ( y ) = - \frac{{V}_{F} ( y )}{{V}_{b}} {Q}_{ch0} & ( 3.1 .14 ) \\ {V}_{b} = \frac{{V}_{gtseff} 2 ν t}{{A}_{bulk}} & ( 3.1 .15 ) \\ {Q}_{ch} ( y ) = {C}_{axeff} \cdot {V}_{gsteff} \cdot ( 1 - \frac{{V}_{F} ( y )}{{V}_{b}} ) & ( 3.1 .16 )\end{matrix}$$

Subthreshold Swing

$${I}_{ds} = {I}_{0} [ 1 - exp ( - \frac{{V}_{ds}}{{v}_{t}} ) ] \cdot exp ( \frac{{V}_{gs} - {V}_{th} - {V}_{off}^{′}}{{nv}_{t}} ) \qquad ( 3.2 .1 )$$

where

$$\begin{matrix}{I}_{0} = μ \frac{W}{L} \sqrt{\frac{q {ɛ}_{si} NDEP}{2 {Φ}_{s}} {v}_{t}^{2}} & ( 3.2 .2 ) \\ n = 1 + NFACTOR \cdot \frac{{C}_{dep}}{{C}_{oxe}} + \frac{Cdsc\_Term + CIT}{{C}_{oxe}} \\ Cdsc\_Term = ( CDSC + CDSCD \cdot {V}_{ds} + CDSCB \cdot {V}_{bseff} ) \cdot \frac{0.5}{cosh ( DVT1 \frac{{L}_{eff}}{{l}_{t}} ) - 1} & ( 3.2 .3 )\end{matrix}$$

Voltage Across Oxide

$$\begin{matrix}{V}_{oxacc} = {V}_{fbzb} - {V}_{FBeff} & ( 4.2 .1 a ) \\ {V}_{oxdepinv} = {K}_{lox} \sqrt{{Φ}_{s}} + {V}_{gsteff} & ( 4.2 .1 b ) \\ {V}_{fbzb} = {V}_{th} {\vert}_{{zeroV}_{bs} and {v}_{ds}} - {Φ}_{s} - K 1 \sqrt{{Φ}_{s}} \text{and} & ( 4.2 .2 ) \\ {V}_{FBeff} = {V}_{fbzb} - 0.5 [ ( {V}_{fbzb} - {V}_{gb} - 0.02 ) + \sqrt{{( {V}_{fbzb} - {V}_{gb} - 0.02 )}^{2} + 0.08 {V}_{fbzb}} ] & ( 4.2 .3 )\end{matrix}$$

Gate to Substrate Current

$$\begin{matrix}Igbacc = {W}_{eff} {L}_{eff} \cdot A \cdot {T}_{oxRatio} \cdot {V}_{gb} \cdot {V}_{aux} \cdot exp [ - B \cdot TOXE ( AIGBACC - BIGBACC \cdot {V}_{oxacc} ) \cdot ( 1 + CIGBACC \cdot {V}_{oxacc} ) ] \\ {T}_{oxRatio} = {( \frac{TOXREF}{TOXE} )}^{NTOX} \cdot \frac{1}{{TOXE}^{2}} \\ {V}_{aux} = NIGBACC \cdot {v}_{t} \cdot log ( 1 + exp ( - \frac{{V}_{gb} - {V}_{fbzb}}{NIGBACC \cdot {v}_{t}} ) ) & ( 4.3 .1 ) \\ Igbinv = {W}_{eff} {L}_{eff} \cdot A \cdot {T}_{oxRatio} \cdot {V}_{gb} \cdot {V}_{aux} \cdot exp [ - B \cdot TOXE ( AIGBINV - BIGBINV \cdot {V}_{oxdepinv} ) \cdot ( 1 + CIGBINV \cdot {V}_{oxdepinv} ) ] \\ {V}_{aux} = NIGBINV \cdot {v}_{t} \cdot log ( 1 + exp ( \frac{{V}_{oxdepinv} - EIGBINV}{EIGBINV \cdot {v}_{t}} ) ) & ( 4.3 .2 )\end{matrix}$$

Gate to Channel Current

$$\begin{matrix}Igc = {W}_{eff} {L}_{eff} \cdot A \cdot {T}_{oxRatio} \cdot {V}_{gse} \cdot {V}_{aux} \cdot exp [ - B \cdot TOXE ( AIGC - BIGC \cdot {V}_{oxdepinv} ) \cdot ( 1 + CIGC \cdot {V}_{oxdepinv} ) ] \\ {V}_{aux} = NIGC \cdot {v}_{t} \cdot log ( 1 + exp ( \frac{{V}_{gse} - VTH0}{NIGC \cdot {v}_{t}} ) ) & ( 4.3 .3 ) \\ Igs = {W}_{eff} DLCIG \cdot A \cdot {T}_{oxRatioEdge} \cdot {V}_{gs} \cdot {V}_{gs}^{′} \cdot exp [ - B \cdot TOXE \cdot POXEDGE \cdot ( AIGSD - BIGSD \cdot {V}_{gs}^{′} ) \cdot ( 1 + CIGSD \cdot {V}_{gs}^{′} ) ] \\ and & ( 4.3 .4 ) \\ Igd = {W}_{eff} DLCIG \cdot A \cdot {T}_{oxRatioEdge} \cdot {V}_{gd} \cdot {V}_{gd}^{′} \cdot exp [ - B \cdot TOXE \cdot POXEDGE \cdot ( AIGSD - BIGSD \cdot {V}_{gd}^{′} ) \cdot ( 1 + CIGSD \cdot {V}_{gd}^{′} ) ] \\ {T}_{oxRatioEdge} = {( \frac{TOXREF}{TOXE \cdot POXEDGE} )}^{NTOX} \cdot \frac{1}{{( TOXE \cdot POXEDGE )}^{2}} \\ {V}_{gs}^{′} = \sqrt{{( {V}_{gs} - {V}_{fbsd} )}^{2} + 1.0 e - 4} \\ {V}_{gd}^{′} = \sqrt{{( {V}_{gd} - {V}_{fbsd} )}^{2} + 1.0 e - 4} \\ {V}_{fbsd} = \frac{{k}_{B} T}{q} log ( \frac{NGATE}{NSD} ) & ( 4.3 .5 )\end{matrix}$$

Partition
Igc=Igcs+Igcd

$$\begin{matrix}Igc = Igcs + Igcd \\ Igcs = Igc \cdot \frac{PIGCD \cdot {V}_{ds} + exp ( - PIGCD \cdot {V}_{ds} ) - 1 + 1.0 e - 4}{{PIGCD}^{2} \cdot {V}_{ds}^{2} + 2.0 e - 4} & ( 4.3 .6 ) \\ Igcd = Igc \cdot \frac{1 - ( PIGCD \cdot {V}_{ds} + 1 ) \cdot exp ( - PIGCD \cdot {V}_{ds} ) + 1.0 e - 4}{{PIGCD}^{2} \cdot {V}_{ds}^{2} + 2.0 e - 4} & ( 4.3 .7 )\end{matrix}$$

Drain Current Model

Bulk Charge Effect

$$\begin{matrix}{A}_{bulk} = \{ 1 + F\_doping \cdot [ \begin{matrix}\begin{matrix}\frac{A0 \cdot {L}_{eff}}{{L}_{eff} + 2 \sqrt{XJ \cdot {X}_{dep}}} \cdot \\ ( 1 - AGS \cdot {{V}_{gstef} ( \frac{{L}_{eff}}{{L}_{eff} + 2 \sqrt{XJ \cdot {X}_{dep}}} )}^{2} ) +\end{matrix} \\ \frac{B0}{{W}_{eff}^{′} + B1}\end{matrix} ] \cdot \} \frac{1}{1 + KETA \cdot {V}_{bseff}} & ( 5.1 .1 ) \\ F\_doping = \frac{\sqrt{1 + LPEB / {L}_{eff}} {K}_{1 ox}}{2 \sqrt{{Φ}_{s} - {V}_{bseff}}} + {K}_{2 ox} - K3B \frac{TOXE}{{W}_{eff}^{′} + W0} {Φ}_{s} & ( 5.1 .2 )\end{matrix}$$

Unified Mobility Model

$$\begin{matrix}{E}_{eff} = \frac{{Q}_{B} + ( {Q}_{n} / 2 )}{{ɛ}_{si}} & ( 5.2 .1 ) \\ {μ}_{eff} = \frac{{μ}_{0}}{1 + {( {E}_{eff} / {E}_{o} )}^{v}} & ( 5.2 .2 ) \\ {E}_{eff} \approx \frac{{V}_{gs} + {V}_{ih}}{6 TOXE} & ( 5.2 .3 )\end{matrix}$$

mobMod=0

$${μ}_{eff} = \frac{U0}{1 + ( UA + {UCV}_{bseff} )} ( \frac{{V}_{gsteff} + 2 {V}_{ih}}{TOXE} ) + {UB ( \frac{{V}_{gsteff} + 2 {V}_{ih}}{TOXE} )}^{2} \qquad ( 5.2 .4 )$$
mobMod=1

$${μ}_{eff} = \frac{U0}{\begin{matrix}1 + [ UA ( \frac{{V}_{gsteff} + 2 {V}_{ih}}{TOXE} ) + \\ {UB ( \frac{{V}_{gsteff} + 2 {V}_{ih}}{TOXE} )}^{2} ] ( 1 + UC \cdot {V}_{bseff} )\end{matrix}} \qquad ( 5.2 .5 )$$
mobMod=2

$${μ}_{eff} = \frac{U0}{ 1 + ( UA + UC \cdot {V}_{bseff} ) {⌈ \frac{{V}_{gsteff} + {C}_{0} \cdot ( VTHO - VFB - Φs}{TOXE} ⌉}^{EU} } \qquad ( 5.2 .6 )$$

Asymmetric and Bias Dependent Source/Drain Resistance Model
rdsMod=0

$${R}_{ds} ( V ) = \frac{ \{ \begin{matrix}RDSWMIN + RDSW \cdot \\ [ PRWB \cdot ( \sqrt{{Φ}_{s} - {V}_{bseff}} - \sqrt{{Φ}_{s}} ) + \\ \frac{1}{1 + PRWG \cdot {V}_{gseff}} ]\end{matrix} \}}{{( 1 e6 \cdot {W}_{effcj} )}^{WR}} \qquad ( 5.3 .1 )$$
rdsMod=1

$$\begin{matrix}{R}_{d} ( V ) = \frac{ \{ \begin{matrix}RDWMIN + RDW \cdot \\ [ - PRWB \cdot {V}_{bd} + \\ \frac{1}{1 + PRWG \cdot {V}_{gd} - {V}_{fbsd}} ] \end{matrix} \}}{[ {( 1 e6 \cdot {W}_{effcj} )}^{WR} \cdot NF ]} & ( 5.3 .2 ) \\ {R}_{s} ( V ) = \frac{ \{ \begin{matrix}RSWMIN + RSW \cdot \\ [ - PRWB \cdot {V}_{bs} + \\ \frac{1}{1 + PRWG \cdot ( {V}_{gs} - {V}_{fbsd} )} ] \end{matrix} \}}{[ {( 1 e6 \cdot {W}_{effcj} )}^{WR} \cdot NF ]} & ( 5.3 .3 . )\end{matrix}$$

Drain Current for Triode Region
rdsMod=1

$$\begin{matrix}{I}_{ds} ( y ) = {WQ}_{ch} ( y ) {μ}_{ne} ( y ) \frac{ⅆ {V}_{F} ( y )}{ⅆ y} & ( 5.4 .1 ) \\ {μ}_{ne ( y )} = \frac{{μ}_{eff}}{1 + \frac{{E}_{y}}{{E}_{sat}}} & ( 5.4 .2 ) \\ {I}_{ds} ( y ) = {WQ}_{ch0} ( 1 - \frac{{V}_{F} ( y )}{{V}_{b}} ) \frac{{μ}_{eff}}{1 + \frac{{E}_{y}}{{E}_{sat}}} \frac{ⅆ {V}_{F} ( y )}{ⅆ y} & ( 5.4 .3 ) \\ {I}_{ds0} = \frac{W {μ}_{eff} {Q}_{ch0} {V}_{ds} ( 1 - \frac{{V}_{ds}}{2 {V}_{b}} )}{L ( 1 + \frac{{V}_{ds}}{{E}_{sat} L} )} . & ( 5.4 .4 )\end{matrix}$$
rdsMod=0

$${I}_{ds} = \frac{{I}_{dso}}{1 + \frac{{R}_{ds} {I}_{dso}}{{V}_{ds}}} \qquad ( 5.4 .5 )$$

Velocity Saturation

$$\begin{matrix}v = \frac{{μ}_{eff} E}{1 + E / {E}_{sat}} E < {E}_{sat} \\ = VSAT E \geq {E}_{sat} & ( 5.5 .1 ) \\ {E}_{sat} = \frac{2 VSAT}{{μ}_{eff}} & ( 5.5 .2 )\end{matrix}$$

Saturation Voltage Vdsat

Intrinsic

$${V}_{dsat} = \frac{{E}_{sat} L ( {V}_{gsteff} + {2}_{Vt} )}{{A}_{bulk} {E}_{sat} L + {V}_{gsteff} + {2}_{vt}} . \qquad ( 5.6 .1 )$$

Extrinsic

$$\begin{matrix}{V}_{dsat} = \frac{- b - \sqrt{{b}^{2} - 4 ac}}{2 a} & ( 5.6 .2 a ) \\ a = {A}_{bulk}^{2} {W}_{eff} {VSATC}_{oxe} {R}_{ds} + {A}_{bulk} ( \frac{1}{λ} - 1 ) & ( 5.6 .2 b ) \\ b = - [ \begin{matrix}( {V}_{gsteff} + 2 {v}_{t} ) ( \frac{2}{λ} - 1 ) + {A}_{bulk} {E}_{sat} {L}_{eff} + \\ 3 {A}_{bulk} ( {V}_{gsteff} + 2 {v}_{t} ) {W}_{eff} {VSATC}_{oxe} {R}_{ds}\end{matrix} ] & ( 5.6 .2 c ) \\ c = ( {V}_{gsteff} + 2 {v}_{t} ) {E}_{sat} {L}_{eff} + 2 {( {V}_{gsteff} + 2 {v}_{t} )}^{2} {W}_{eff} {VSATC}_{oxe} {R}_{ds} & ( 5.6 .2 d ) \\ λ = {A1V}_{gsteff} + A2 & ( 5.6 .2 e )\end{matrix}$$

c=(V_{gsteff}+2ν₁)EₛₐₜL_{eff}+2(V_{gsteff}+2ν₁)²W_{eff}VSATCₒₓₑR_{ds} (5.6.2d)
λ=A1V_{gsteff}+A2 (5.6.2e)
Vdseff

$${V}_{dseff} = {V}_{dsat} - \frac{1}{2} [ ( {V}_{dsat} - {V}_{ds} - δ ) + \sqrt{( {V}_{dsat} - {V}_{ds} - {δ}^{2} ) + 4 δ \cdot {V}_{dsat}} ] \qquad ( 5.6 .3 )$$

Saturation-Region Output Conductance Model

$$\begin{matrix}{I}_{ds} ( {V}_{gs} , {V}_{ds} ) = {I}_{dsat} ( {V}_{gs} , {V}_{dsat} ) + {\int }_{{V}_{dsat}}^{{V}_{ds}} \frac{\partial {I}_{ds} ( {V}_{gs} , {V}_{ds} )}{\partial {V}_{d}} \cdot ⅆ {V}_{d} & ( 5.7 .1 ) \\ = {I}_{dsat} ( {V}_{gs} , {V}_{dsat} ) \cdot [ 1 + {\int }_{{V}_{dsat}}^{{V}_{ds}} \frac{1}{{V}_{A}} \cdot ⅆ {V}_{d} ] & \\ {V}_{A} = {I}_{dsat} \cdot {[ \frac{\partial {I}_{ds} ( {V}_{gs} , {V}_{ds} )}{\partial {V}_{d}} ]}^{- 1} & ( 5.7 .2 )\end{matrix}$$

Channel Length Modulation

$$\begin{matrix}{V}_{ACLM} = {I}_{dsat} \cdot {[ \frac{\partial {I}_{ds} ( {V}_{gs} , {V}_{ds} )}{\partial L} \cdot \frac{\partial L}{\partial {V}_{d}} ]}^{- 1} & ( 5.7 .3 ) \\ {V}_{ACLM} = {C}_{clm} \cdot ( {V}_{ds} - {V}_{dsat} ) & ( 5.7 .4 ) \\ {C}_{clm} = \frac{1}{PCLM} \cdot F \cdot ( 1 + PVAG \frac{{V}_{gsteff}}{{E}_{sat} {L}_{eff}} ) ( 1 + \frac{{R}_{ds} \cdot {I}_{dso}}{{V}_{dseff}} ) ( {L}_{eff} + \frac{{V}_{dsat}}{{E}_{sat}} ) \cdot \frac{1}{litl} & ( 5.7 .5 ) \\ F = \frac{1}{1 + FPROUT \cdot \frac{\sqrt{{L}_{eff}}}{{V}_{gsteff} + 2 {v}_{t}}} & ( 5.7 .6 ) \\ litl = \sqrt{\frac{{ɛ}_{si} TOXE \cdot XJ}{EPSROX}} & ( 5.7 .7 )\end{matrix}$$

Drain Induced Barrier Lower (DIBL)

$$\begin{matrix}{V}_{ADIBL} = {I}_{dsat} \cdot {[ \frac{\partial {I}_{ds} ( {V}_{gs} , {V}_{ds} )}{\partial {V}_{th}} \cdot \frac{\partial {V}_{th}}{\partial {V}_{d}} ]}^{- 1} & ( 5.7 .8 ) \\ {V}_{ADIBL} = \frac{{V}_{gsteff} + 2 {v}_{t}}{{θ}_{rout} ( 1 + PDIBLCB \cdot {V}_{bseff} )} ( 1 - \frac{{A}_{bulk} {V}_{dsat}}{{A}_{bulk} {V}_{dsat} + {V}_{gsteff} + 2 {v}_{t}} ) \cdot ( 1 + PVAG \frac{{V}_{gsteff}}{{E}_{sat} {L}_{eff}} ) & ( 5.7 .9 ) \\ {θ}_{rout} = \frac{PDIBLC1}{2 cosh ( \frac{DROUT \cdot {L}_{eff}}{lt0} ) - 2} + PDIBLC2 & ( 5.7 .10 )\end{matrix}$$

Substrate Current Induced Body Effect (SCBE)

$$\begin{matrix}{I}_{sub} = \frac{{A}_{i}}{{B}_{i}} {I}_{ds} ( {V}_{ds} - {V}_{dsat} ) exp ( - \frac{{B}_{i} \cdot litl}{{V}_{ds} - {V}_{dsat}} ) & ( 5.7 .11 ) \\ {I}_{ds} = {I}_{ds - w / o - Isub} + {I}_{sub} & ( 5.7 .12 ) \\ = {I}_{ds - w / o - Isub} \cdot [ 1 + \frac{{V}_{ds} - {V}_{dsat}}{\frac{{B}_{i}}{{A}_{i}} exp ( \frac{{B}_{i} \cdot litl}{{V}_{ds} - {V}_{dsat}} )} ] & \\ {V}_{ASCBE} = \frac{{B}_{i}}{{A}_{i}} exp ( \frac{{B}_{i} \cdot litl}{{V}_{ds} - {V}_{dsat}} ) & ( 5.7 .13 ) \\ \frac{1}{{V}_{ASCBE}} = \frac{PSCBE2}{{L}_{eff}} exp ( - \frac{PSCBE1 \cdot litl}{{V}_{ds} - {V}_{dsat}} ) . & ( 5.7 .14 )\end{matrix}$$

Drain Induced Threshold Shift (DITS)

$${V}_{ADITS} = \frac{1}{PDITS} \cdot F \cdot [ 1 + ( 1 + PDITSL \cdot {L}_{eff} ) exp ( PDITSD \cdot {V}_{ds} ) ] \qquad ( 5.7 .15 )$$

Single Equation Channel Current Model

$${I}_{ds} = \frac{{I}_{ds0} \cdot NF}{1 + \frac{{R}_{ds} {I}_{ds0}}{{V}_{dseff}}} [ 1 + \frac{1}{{C}_{clm}} ln ( \frac{{V}_{A}}{{V}_{Asat}} ) ] \cdot ( 1 + \frac{{V}_{ds} - {V}_{dseff}}{{V}_{ADIBL}} ) \cdot ( 1 + \frac{{V}_{ds} - {V}_{dseff}}{{V}_{ADITS}} ) \cdot ( 1 + \frac{{V}_{ds} - {V}_{dseff}}{{V}_{ASCBE}} ) \qquad ( 5.8 .1 )$$

where NF is the number of device fingers, and
V_{A} is written as (5.8.2)
V_{A}=V_{Asat}+V_{ACLM} (5.8.3)

$$\begin{matrix}{V}_{A} is written as & ( 5.8 .2 ) \\ {V}_{A} = {V}_{Asat} + {V}_{ACLM} & ( 5.8 .3 ) \\ {V}_{Asat} = \frac{\begin{matrix}{E}_{sat} {L}_{eff} + {V}_{dsat} + \\ 2 {R}_{ds} {vsatC}_{oxe} {W}_{eff} {V}_{gsteff} \cdot ⌊ 1 - \frac{{A}_{bulk} {V}_{dsat}}{2 ( {V}_{gsteff} + 2 {v}_{t} )} ⌋\end{matrix}}{{R}_{ds} {vsatC}_{oxe} {W}_{eff} {A}_{bulk} - 1 + \frac{2}{λ}} & ( 5.8 .4 )\end{matrix}$$

Body Current Model

Iii Model

$$\begin{matrix}\begin{matrix}{I}_{u} = \frac{ALPHA0 + ALPHA1 \cdot {L}_{eff}}{{L}_{eff}} ( {V}_{ds} - {V}_{dseff} ) exp \\ ( \frac{BETA0}{{V}_{ds} - {V}_{dseff}} ) \cdot {I}_{dsNoSCBE}\end{matrix} & ( 6.1 .1 ) \\ \begin{matrix}{I}_{dsNoSCBE} = \frac{{I}_{ds0} \cdot NF}{1 + \frac{{R}_{ds} {I}_{ds0}}{{V}_{dseff}}} [ 1 + \frac{1}{{C}_{clm}} ln ( \frac{{V}_{A}}{{V}_{Asat}} ) ] \cdot \\ ( 1 + \frac{{V}_{ds} - {V}_{dseff}}{{V}_{ADIBL}} ) \cdot ( 1 + \frac{{V}_{ds} - {V}_{dseff}}{{V}_{ADITS}} )\end{matrix} & ( 6.1 .2 )\end{matrix}$$

Igidl Model

$$\begin{matrix}{I}_{GIDL} = AGIDL \cdot {W}_{effCl} \cdot Nf \cdot \frac{{V}_{ds} - {V}_{gse} - EGIDL}{3 \cdot {T}_{oxe}} \cdot \\ exp ( - \frac{3 \cdot {T}_{oxe} \cdot BGIDL}{{V}_{ds} - {V}_{gse} - EGIDL} ) \cdot \frac{{V}_{db}^{3}}{CGIDL + {V}_{db}^{3}}\end{matrix} \qquad ( 6.2 .1 )$$

Intrinsic Capacitance Modeling
Basic Formulation

$$\begin{matrix}\{ \begin{matrix}\begin{matrix}{Q}_{g} = - ( {Q}_{sub} + {Q}_{inv} + {Q}_{acc} ) \\ {Q}_{b} = {Q}_{acc} + {Q}_{sub}\end{matrix} \\ {Q}_{inv} = {Q}_{s} + {Q}_{d}\end{matrix} & ( 7.2 .1 ) \\ {Q}_{g} = - ( {Q}_{inv} + {Q}_{acc} + {Q}_{sub0} + δ {Q}_{sub} ) & ( 7.2 .2 ) \\ {V}_{th} ( y ) = {V}_{th} ( 0 ) + ( {A}_{built} - 1 ) {V}_{y} & ( 7.2 .3 ) \\ \{ \begin{matrix}{Q}_{c} = {W}_{active} {\int }_{0}^{{L}_{active}} {q}_{c} ⅆ y = - {W}_{active} {C}_{oxe} {\int }_{0}^{{L}_{active}} ( {V}_{gt} - {A}_{bulk} {V}_{y} ) ⅆ y \\ {Q}_{g} = {W}_{active} {\int }_{0}^{{L}_{active}} {q}_{g} ⅆ y = {W}_{active} {C}_{oxe} {\int }_{0}^{{L}_{active}} ( {V}_{gt} + {V}_{th} - {V}_{FB} - {Φ}_{s} - {V}_{y} ) ⅆ y \\ {Q}_{b} = {W}_{active} {\int }_{0}^{{L}_{active}} {q}_{b} ⅆ y = - {W}_{active} {C}_{oxe} {\int }_{0}^{{L}_{active}} ( {V}_{th} - {V}_{FB} - {Φ}_{s} + ( {A}_{bulk} - 1 ) {V}_{y} ) ⅆ y\end{matrix} & ( 7.2 .4 )\end{matrix}$$

where V_{gt}=V_{gse}−Vₜₕ and

$$dy = \frac{{dV}_{y}}{{E}_{y}}$$

$$\begin{matrix}\begin{matrix}{I}_{ds} = \frac{{W}_{active} {μ}_{eff} {C}_{oxe}}{{L}_{active}} ( {V}_{gt} - \frac{{A}_{bulk}}{2} {V}_{ds} ) {V}_{ds} \\ = {W}_{active} {μ}_{eff} {C}_{oxe} ( {V}_{gt} - {A}_{bulk} {V}_{y} ) {E}_{y}\end{matrix} & ( 7.2 .5 ) \\ {C}_{ij} = \frac{\partial {Q}_{i}}{\partial {V}_{j}} & ( 7.2 .6 )\end{matrix}$$

where i and j denote the transistor terminals, Cᵢⱼ satisfies

$${\sum }_{i} {C}_{ij} = {\sum }_{j} {C}_{ij} = 0$$

Short Channel Model

$$\begin{matrix}{V}_{dsat , IV} < {V}_{dsat , CV} < {V}_{dsat , IV} {\vert}_{Lactive -> ∞} = \frac{{V}_{gsteff , CV}}{{A}_{bulk}} & ( 7.2 .7 ) \\ {V}_{dsat , CV} = \frac{{V}_{gsteff , CV}}{{A}_{bulk} \cdot [ 1 + {( \frac{CLC}{{L}_{active}} )}^{CLE} ]} & ( 7.2 .8 ) \\ \begin{matrix}{V}_{gsteff , CV} = NOFF \cdot {nv}_{t} \cdot \\ ln [ 1 + exp ( \frac{{V}_{gse} - {V}_{th} - VOFFCV}{NOFF \cdot {nv}_{t}} ) ]\end{matrix} & ( 7.2 .9 ) \\ \begin{matrix}{A}_{bulk} = \{ 1 + F\_doping \cdot \\ [ \frac{A0 \cdot {L}_{eff}}{{L}_{eff} + 2 \sqrt{XJ \cdot {X}_{dep}}} \cdot + \frac{B0}{{W}_{eff}^{′} + B1} ] \cdot \} \\ \frac{1}{1 + KETA \cdot {V}_{bseff}}\end{matrix} \\ where \\ \begin{matrix}F\_doping = \frac{\sqrt{1 + LPEB / {L}_{eff}} {K}_{1 ox}}{2 \sqrt{{Φ}_{s} - {V}_{bseff}}} + \\ K3B \frac{TOXE}{{W}_{eff}^{′} + W0} {Φ}_{s}\end{matrix} {K}_{2 ox} - & ( 7.2 .10 )\end{matrix}$$

Single Equation Formulation
depletion to inversion region

$$\begin{matrix}Q ( {V}_{gst} ) = Q ( {V}_{gsteff , CV} ) & ( 7.2 .11 ) \\ C ( {V}_{gst} ) = C ( {V}_{gsteff , CV} ) \frac{\partial {V}_{gsteff , CV}}{{V}_{g , d , s , b}} & ( 7.2 .12 )\end{matrix}$$

Accumulation to Depletion Region

$$\begin{matrix}{V}_{FBeff} = {V}_{fbzb} - 0.5 [ ( {V}_{fbzb} - {V}_{gb} - 0.02 ) + \\ \sqrt{{( {V}_{fbzb} - {V}_{gb} - 0.02 )}^{2} + 0.08 {V}_{fbzb}} ]\end{matrix} \qquad ( 7.2 .13 )$$

V_{fbzb}=Vₜₕ|_{zeroV}_{_{bs}}_{andV}_{_{ds}}−Φₛ−K1\sqrt{Φₛ} (7.2.14)
Linear to Saturation Region

$${V}_{coeff} = {V}_{dsat , CV} - 0.5 \{ {V}_{4} + \sqrt{{V}_{4}^{2} + 4 {δ}_{4} {V}_{dsat , CV}} \} \text{where} {V}_{4} = {V}_{dsat , CV} - {V}_{ds} - {δ}_{4} ; {δ}_{4} = 0.02 V \qquad ( 7.2 .15 )$$

Charge Petitioning

$$\{ \begin{matrix}{Q}_{s} = {W}_{active} {\int }_{0}^{{L}_{active}} {q}_{c} ( I - \frac{y}{{L}_{active}} ) ⅆ y \\ {Q}_{d} = {W}_{active} {\int }_{0}^{{L}_{active}} {q}_{c} \frac{y}{{L}_{active}} ⅆ y\end{matrix} \qquad ( 7.2 .16 )$$

Charge—Thickness Capacitance Model

$${C}_{oxeff} = \frac{{C}_{oxe} \cdot {C}_{cen}}{{C}_{oxe} + {C}_{cen}} \qquad ( 7.3 .1 )$$
where
C_{cen}=εₛᵢ/X_{DC}
Accumulation and Depletion

$$\begin{matrix}{X}_{DC} = \frac{1}{3} {L}_{debye} \\ exp [ ACDE \cdot {( \frac{NDEP}{2 \times {10}^{16}} )}^{- 0.25} \cdot \frac{{V}_{gse} - {V}_{bseff} - {V}_{FBeff}}{TOXE} ]\end{matrix} \qquad ( 7.3 .2 )$$
where L_{debye} is Debye length, and X_{DC} is in the unit of cm and (V_{gse}−V_{bseff}−V_{FBeff})/TOXE is in units of MV/Cm. For numerical statbility, (7.3.2) is replaced by (7.3.3)

$${X}_{DC} = {X}_{max} - \frac{1}{2} ( {X}_{0} + \sqrt{{X}_{0}^{2} + 4 {δ}_{x} {X}_{max}} ) \qquad ( 7.3 .3 )$$

where
X₀=Xₘₐₓ−X_{DC}−δₓ
and Xₘₐₓ=L_{debye}/3; δₓ=10⁻³TOXE.
Inversion Charge

$${X}_{DC} = \frac{1.9 \times {10}^{- 9} cm}{1 + {( \frac{{V}_{gsteff} + 4 ( VTH0 - VFB - {Φ}_{s} )}{2 TOXP} )}^{0.7}} \qquad ( 7.3 .5 )$$

Body Charge Thickness in Inversion

$${φ}_{δ} = {Φ}_{s} - 2 {Φ}_{B} = {v}_{t} ln ( \frac{{V}_{gsteffCV} \cdot ( {V}_{gsteffCV} + 2 {K}_{1 ox} \sqrt{2 {Φ}_{B}}}{MOIN \cdot {K}_{1 ox}^{2} {v}_{t}} ) \qquad ( 7.3 .5 )$$

qᵢₙᵥ=−C_{oseff}·(V_{gseff,CV}−φ_{δ}) (7.3.6)
Intrinsic Capacitance Model Equations

Accumulation Region
Q_{δ}=W_{active}L_{active}Cₒₓₑ(V_{gs}−V_{bs}−VFBCV)
Q_{sub}=−Qₛ
Qᵢₙᵥ=0

Subthreshold Region

$$\begin{matrix}{Q}_{sub0} = - {W}_{active} {L}_{active} {C}_{oxe} \cdot \\ \frac{{K}_{1 ox}^{2}}{2} ( - 1 + \sqrt{1 + \frac{4 ( {V}_{gs} - VFBCV - {V}_{bs} )}{{K}_{1 ox}^{2}}} )\end{matrix}$$

$${Q}_{g} = - {Q}_{sub0}$$

$${Q}_{inv} = 0$$

Strong Inversion Region

$${V}_{dsat , cv} = \frac{{V}_{gs} - {V}_{th}}{{A}_{bulk}^{′}}$$

$${A}_{bulk}^{′} = {A}_{bulk} ( 1 + {( \frac{CLC}{{L}_{eff}} )}^{CLE} )$$

$${V}_{th} = VFBCV + {Φ}_{s} + {K}_{1 ox} \sqrt{{Φ}_{s} - {V}_{bseff}}$$

Vₜₕ=VFBCV+φₛ+Kₗₒₓ\sqrt{Φₛ−V_{bseff}}

Linear Region

$$\begin{matrix}{Q}_{g} = {C}_{oxe} {W}_{active} {L}_{active} \\ ( {V}_{gs} - VFBCV - {Φ}_{s} - \frac{{V}_{ds}}{2} + \frac{{A}_{bulk}^{′} {V}_{ds}^{2}}{12 ( {V}_{gs} - {V}_{th} - \frac{{A}_{bulk}^{′} {V}_{ds}}{2} )} )\end{matrix}$$

$$\begin{matrix}{Q}_{b} = {C}_{oxe} {W}_{active} {L}_{active} ( VFBCV - {V}_{th} - {Φ}_{s} - \\ \frac{( 1 - {A}_{bulk}^{′} ) {V}_{ds}}{2} - \frac{( 1 - {A}_{bulk}^{′} ) {A}_{bulk}^{′} {V}_{ds}^{2}}{12 ( {V}_{gs} - {V}_{th} - \frac{{A}_{bulk}^{′} {V}_{ds}}{2} )} )\end{matrix}$$

50/50 Partitioning:

$$\begin{matrix}{Q}_{inv} = - {C}_{oxe} {W}_{active} {L}_{active} \\ \{ {V}_{gs} - {V}_{th} - {Φ}_{s} - \frac{{A}_{bulk}^{′} {V}_{ds}}{2} + \frac{{A}_{bulk}^{′2} {V}_{ds}^{2}}{12 ( {V}_{gs} - {V}_{th} - \frac{{A}_{bulk}^{′} {V}_{ds}}{2} )} )\end{matrix}$$

$${Q}_{s} = {Q}_{d} = 0.5 {Q}_{inv}$$

Qₛ=Q_{d}=0.5Qᵢₙᵥ

40/60 Partitioning:

$$\begin{matrix}{Q}_{d} = - {C}_{oxe} {W}_{active} {L}_{active} \\ ( \frac{{V}_{gs} - {V}_{th}}{2} - \frac{{A}_{bulk}^{′} {V}_{ds}}{2} + \\ \frac{{A}_{bulk}^{′} {V}_{ds} [ \frac{{( {V}_{gs} - {V}_{th} )}^{2}}{6} - \frac{{A}_{bulk}^{′} {V}_{ds} ( {V}_{gs} - {V}_{th} )}{8} + \frac{{( {A}_{bulk}^{′} {V}_{ds} )}^{2}}{40} ]}{12 {( {V}_{gs} - {V}_{th} - \frac{{A}_{bulk}^{′} {V}_{ds}}{2} )}^{2}} )\end{matrix}$$

$${Q}_{s} = - ( {Q}_{g} + {Q}_{b} + {Q}_{d} )$$

Qₛ=−(Qₛ+Q_{b}+Q_{d})

0/100 Partitioning:

$${Q}_{d} = - {C}_{oxe} {W}_{active} {L}_{active} ( \frac{{V}_{gs} - {V}_{th}}{2} + \frac{{A}_{bulk}^{′} {V}_{ds}}{4} - \frac{{( {A}_{bulk}^{′} {V}_{ds} )}^{2}}{24} )$$

$${Q}_{s} = - ( {Q}_{g} + {Q}_{b} + {Q}_{d} )$$

Qₛ=−(Q_{g}+Q_{b}+Q_{d})

Saturation Region

$${Q}_{g} = {C}_{oxe} {W}_{active} {L}_{active} ( {V}_{gs} - VFBCV - {Φ}_{s} - \frac{{V}_{dsat}}{3} )$$

$${Q}_{b} = - {C}_{oxe} {W}_{active} {L}_{active} ( VFBCV + {Φ}_{s} - {V}_{th} + \frac{( 1 - {A}_{bulk}^{′} ) {V}_{dsat}}{3} )$$

50/50 Partitioning:

$${Q}_{s} = {Q}_{d} = - \frac{1}{3} {C}_{axe} {W}_{active} {L}_{active} ( {V}_{gs} - {V}_{th} )$$

40/60 Partitioning:

$${Q}_{d} = - \frac{4}{15} {C}_{axe} {W}_{active} {L}_{active} ( {V}_{gs} - {V}_{th} )$$

Qₛ=−(Q_{g}+Q_{b}+Q_{d})

0/100 Partitioning:
Q_{d}=0
Qₛ=−(Q_{g}+Q_{b})
capMod=1
Q_{g}=−(Qᵢₙᵥ+Q_{acc}+Q_{sub0}+δQ_{sub})
Q_{b}=−(Q_{acc}+Q_{sub0}+δQ_{sub})
Qᵢₙᵥ=Qₛ+Q_{d}
Q_{acc}=−W_{active}L_{active}Cₒₓₑ·(V_{FBeff}−V_{fbzb})

$${Q}_{g} = - ( {Q}_{inv} + {Q}_{acc} + {Q}_{sub0} + δ {Q}_{sub} )$$

$${Q}_{b} = - ( {Q}_{acc} + {Q}_{sub0} + δ {Q}_{sub} )$$

$${Q}_{inv} = {Q}_{s} + {Q}_{d}$$

$${Q}_{acc} = - {W}_{active} {L}_{active} {C}_{oxe} \cdot ( {V}_{FBeff} - {V}_{fbzb} )$$

$${Q}_{sub0} = - {W}_{active} {L}_{active} {C}_{oxe} \cdot \frac{{K}_{1 ox}^{2}}{2} \cdot [ - 1 + \sqrt{1 + \frac{4 ( {V}_{gse} - {V}_{FBeff} - {V}_{gsteff} - {V}_{bseff} )}{{K}_{1 ox}^{2}}} ]$$

$${V}_{dsat , cv} = \frac{{V}_{gsteffcv}}{{A}_{bulk}} , \\ {Q}_{inv} = - {W}_{active} {L}_{active} {C}_{oxe} \cdot [ {V}_{gsteff , cv} - \frac{1}{2} {A}_{bulk}^{′} {V}_{cveff} + \frac{{A}_{bulk}^{′2} {V}_{cveff}^{2}}{12 \cdot ( {V}_{gsteff , cv} - {A}_{bulk}^{′} {V}_{cveff} / 2 )} ]$$

$$δ {Q}_{sub} = {W}_{active} {L}_{active} {C}_{oxe} \cdot [ \frac{1 - {A}_{bulk}^{′}}{2} {V}_{cveff} - \frac{( 1 - {A}_{bulk}^{′} ) \cdot {A}_{bulk}^{′} {V}_{cveff}^{2}}{12 \cdot ( {V}_{gsteff , cv} - {A}_{bulk}^{′} {V}_{cveff} / 2 )} ]$$

50/50 Charge Partitioning:

$${Q}_{S} = {Q}_{D} = - \frac{{W}_{active} {L}_{active} {C}_{oxe}}{2} [ {V}_{gsteff , cv} - \frac{1}{2} {A}_{bulk}^{′} {V}_{cveff} + \frac{{A}_{bulk}^{′2} {V}_{cveff}^{2}}{12 \cdot ( {V}_{gsteff} - {A}_{bulk}^{′} {V}_{cveff} / 2 )} ]$$

40/60 Charge Partitioning:

$${Q}_{S} = - \frac{{W}_{active} {L}_{active} {C}_{oxe}}{2 {( {V}_{gsteff , cv} - {A}_{bulk}^{′} {V}_{cveff} / 2 )}^{2}} [ \begin{matrix}{V}_{gsteff , cv}^{3} - \frac{4}{3} {V}_{gsteff , cv}^{2} {A}_{bulk}^{′} {V}_{cveff} + \\ \frac{2}{3} {{V}_{gsteff , cv} ( {A}_{bulk}^{′} {V}_{cveff} )}^{2} - \frac{2}{15} {( {A}_{bulk}^{′} {V}_{cveff} )}^{3}\end{matrix} ]$$

$${Q}_{D} = - \frac{{W}_{active} {L}_{active} {C}_{oxe}}{2 {( {V}_{gsteff , cv} - {A}_{bulk}^{′} {V}_{cveff} / 2 )}^{2}} [ \begin{matrix}{V}_{gsteff , cv}^{3} - \frac{5}{3} {V}_{gsteff , cv}^{2} {A}_{bulk}^{′} {V}_{cveff} + \\ {{V}_{gsteff , cv} ( {A}_{bulk}^{′} {V}_{cveff} )}^{2} - \frac{1}{5} {( {A}_{bulk}^{′} {V}_{cveff} )}^{3}\end{matrix} ]$$

0/100 Charge Partitioning:

$${Q}_{S} = - \frac{{W}_{active} {L}_{active} {C}_{oxe}}{2} \cdot [ \begin{matrix}{V}_{gsteff , cv}^{3} + \frac{1}{2} {A}_{bulk}^{′} {V}_{cveff} - \\ \frac{{A}_{bulk}^{′2} {V}_{cveff}^{2}}{12 \cdot ( {V}_{gsteff , cv} - {A}_{bulk}^{′} {V}_{cveff} / 2 )}\end{matrix} ]$$

$${Q}_{D} = - \frac{{W}_{active} {L}_{active} {C}_{oxe}}{2} \cdot [ \begin{matrix}{V}_{gsteff , cv}^{3} - \frac{3}{2} {A}_{bulk}^{′} {V}_{cveff} + \\ \frac{{A}_{bulk}^{′2} {V}_{cveff}^{2}}{4 \cdot ( {V}_{gsteff , cv} - {A}_{bulk}^{′} {V}_{cveff} / 2 )}\end{matrix} ]$$

capMod=2

$${Q}_{ace} = {W}_{active} {L}_{active} {C}_{oxeff} \cdot {V}_{gbacc}$$

$${V}_{gbacc} = \frac{1}{2} \cdot [ {V}_{0} + \sqrt{{V}_{0}^{2} + 0.08 {V}_{fbzb}} ]$$

$${V}_{0} = {V}_{fbzb} + {V}_{bseff} - {V}_{gs} - 0.02$$

$${V}_{cveff} = {V}_{dsat} - \frac{1}{2} \cdot ( {V}_{1} + \sqrt{{V}_{1}^{2} + 0.08 {V}_{dsat}} )$$

$${V}_{1} = {V}_{dsat} - {V}_{ds} - 0.02$$

$${V}_{dsat} = \frac{{V}_{gsteff , cv} - {φ}_{δ}}{{A}_{bulk}^{′}}$$

$${φ}_{δ} = {Φ}_{s} - 2 {Φ}_{B} = {v}_{t} ln ( \frac{{V}_{gsteffCV} \cdot {V}_{gsteffCV} + 2 {K}_{1 ox} \sqrt{2 {Φ}_{B}}}{MOIN \cdot {K}_{1 ox}^{2} {v}_{t}} )$$

$${Q}_{sub0} = - {W}_{active} {L}_{active} {C}_{axeff} \cdot \frac{{K}_{1 ox}^{2}}{2} \cdot [ - 1 + \sqrt{1 + \frac{4 ( {V}_{gse} - {V}_{FBeff} - {V}_{bseffs} - {V}_{gsteff , cv} )}{{K}_{1 ox}^{2}}} ]$$

$${Q}_{inv} = - {W}_{active} {L}_{active} {C}_{oxeff} \cdot [ {V}_{gsteff . cv} - {φ}_{δ} - \frac{1}{2} {A}_{bulk}^{′} {V}_{cveff} + \frac{{A}_{bulk}^{′2} {V}_{cveff}^{2}}{12 \cdot ( {V}_{gsteff , cv} - {φ}_{δ} - {A}_{bulk}^{′} {V}_{cveff} / 2 )} ]$$

$$δ {Q}_{sub} = {W}_{active} {L}_{active} {C}_{axeff} \cdot [ \frac{1 - {A}_{bulk}^{′}}{2} {V}_{cveff} - \frac{( 1 - {A}_{bulk}^{′} ) \cdot {A}_{bulk}^{′} {V}_{cveff}^{2}}{12 \cdot ( {V}_{gsteff , cv} - {φ}_{δ} - {A}_{bulk}^{′} {V}_{cveff} / 2 )} ]$$

50/50 Partitioning:

$${Q}_{S} = {Q}_{D} = - \frac{{W}_{active} {L}_{active} {C}_{axeff}}{2} [ {V}_{gsteff , cv} - {φ}_{δ} - \frac{1}{2} {A}_{bulk}^{′} {V}_{cveff} + \frac{{A}_{bulk}^{′2} {V}_{cveff}^{2}}{12 \cdot ( {V}_{gsteff , cv} - {φ}_{δ} - {A}_{bulk}^{′} {V}_{cveff} / 2 )} ]$$

40/60 Partitioning:

$$\begin{matrix}{Q}_{S} = - \frac{{W}_{active} {L}_{active} {C}_{oxeff}}{2 {( {V}_{gsteff , cv} - {φ}_{δ} - \frac{{A}_{bulk}^{′} {V}_{cveff}}{2} )}^{2}} \\ [ \begin{matrix}{( {V}_{gsteff , cv} - {φ}_{δ} )}^{3} - \frac{4}{3} {( {V}_{gsteff , cv} - {φ}_{δ} )}^{2} {A}_{bulk}^{′} {V}_{cveff} + \\ \frac{2}{3} ( {V}_{gsteff , cv} - {φ}_{δ} ) {( {A}_{bulk}^{′} {V}_{cveff} )}^{2} - \frac{2}{15} {( {A}_{bulk}^{′} {V}_{cveff} )}^{3}\end{matrix} ] \\ {Q}_{D} = - \frac{{W}_{active} {L}_{active} {C}_{oxeff}}{2 {( {V}_{gsteff , cv} - {φ}_{δ} - \frac{{A}_{bulk}^{′} {V}_{cveff}}{2} )}^{2}} \\ [ \begin{matrix}{( {V}_{gsteff , cv} - {φ}_{δ} )}^{3} - \frac{5}{3} {( {V}_{gsteff , cv} - {φ}_{δ} )}^{2} {A}_{bulk}^{′} {V}_{cveff} + \\ ( {V}_{gsteff , cv} - {φ}_{δ} ) {( {A}_{bulk}^{′} {V}_{cveff} )}^{2} - \frac{1}{5} {( {A}_{bulk}^{′} {V}_{cveff} )}^{3}\end{matrix} ]\end{matrix}$$

0/100 Partitioning:

$$\begin{matrix}{Q}_{S} = - \frac{{W}_{active} {L}_{active} {C}_{oxeff}}{2} \cdot [ {V}_{gsteff , cv} - {φ}_{δ} + \frac{1}{2} {A}_{bulk}^{′} {V}_{cveff} - \\ \frac{{A}_{bulk}^{′ 2} {V}_{cveff}^{2}}{12 \cdot ( {V}_{gsteff , cv} - {φ}_{δ} - \frac{{A}_{bulk}^{′} {V}_{cveff}}{2} )} ] \\ {Q}_{D} = - \frac{{W}_{active} {L}_{active} {C}_{oxeff}}{2} \cdot [ {V}_{gsteff , cv} - {φ}_{δ} - \frac{3}{2} {A}_{bulk}^{′} {V}_{cveff} + \\ \frac{{A}_{bulk}^{′ 2} {V}_{cveff}^{2}}{4 \cdot ( {V}_{gsteff , cv} - {φ}_{δ} - \frac{{A}_{bulk}^{′} {V}_{dveff}}{2} )} ]\end{matrix}$$

Fringe Capacitance Model

$$CF = \frac{2 \cdot EPSROX \cdot {ɛ}_{0}}{π} \cdot log ( 1 + \frac{4.0 e - 7}{TOXE} ) \qquad ( 7.5 .1 )$$

Bias-Dependent Overlap Capacitance Model

(i) Source Side

$$\begin{matrix}\frac{{Q}_{overlap , s}}{{W}_{active}} = CGSO \cdot {V}_{gs} + CGSL ( {V}_{gs} - {V}_{gs , overlap} - & ( 7.5 .2 ) \\ \frac{CKAPPAS}{2} ( - 1 + \sqrt{1 - \frac{4 {V}_{gs , overlap}}{CKAPPAS}} ) ) & \\ \begin{matrix}{V}_{gs , overlap} = \frac{1}{2} ( {V}_{gs} + {δ}_{1} - \sqrt{{( {V}_{gs} + {δ}_{1} )}^{2} + 4 {δ}_{1}} ) , & {δ}_{1} = 0.02 V\end{matrix} & ( 7.5 .3 )\end{matrix}$$

(ii) Drain Side

$$\begin{matrix}\frac{{Q}_{overlap , d}}{{W}_{active}} = CGDO \cdot {V}_{gd} + CGDL ( {V}_{gd} - {V}_{gd , overlap} - & ( 7.5 .4 ) \\ \frac{CKAPPAD}{2} ( - 1 + \sqrt{1 - \frac{4 {V}_{gd , overlap}}{CKAPPAD}} ) ) & \\ \begin{matrix}{V}_{gd , overlap} = \frac{1}{2} ( {V}_{gd} + {δ}_{1} - \sqrt{{( {V}_{gd} + {δ}_{1} )}^{2} + 4 {δ}_{1}} ) , & {δ}_{1} = 0.02 V\end{matrix} & ( 7.5 .5 )\end{matrix}$$

(iii) Gate Overlap Charge
Q_{overlap,g}=−(Q_{overlap,d}+Q_{overlap,s}+(CGBO·L_{active})·V_{gb}) (7.5.6)
Bias-Independent Overlap Capacitance Model

The gate-to-source overlap charge is expressed by
Q_{overlap,s}=W_{active}·CGSO·V_{gs}

The gate-to-drain overlap charge is calculated by
Q_{overlap,d}=W_{active}·CGDO·V_{gd}

The gate-to-substrate overlap charge is computed by
Q_{overlap,b}=L_{active}·CGBO·V_{gb}
Charge-Deficit Non-Quasi Static Model

The Transient Model

$$\begin{matrix}{Q}_{def} ( t ) = {V}_{def} \times {C}_{fact} & ( 8.1 .1 ) \\ {i}_{D , G , S} ( t ) = {I}_{D , G , S} ( DC ) + \frac{\partial {Q}_{d , g , s} ( t )}{\partial t} & ( 8.1 .2 ) \\ {Q}_{def} ( t ) = {Q}_{cheq} ( t ) - {Q}_{ch} ( t ) & ( 8.1 .3 ) \\ \frac{\partial {Q}_{def} ( t )}{\partial t} = \frac{\partial {Q}_{cheq} ( t )}{\partial t} - \frac{{Q}_{def} ( t )}{τ} & ( 8.1 .4 a ) \\ \frac{\partial {Q}_{d , g , s} ( t )}{\partial t} = D , G , {S}_{xpart} \frac{{Q}_{def} ( t )}{τ} & ( 8.1 .4 b ) \\ \frac{1}{{R}_{ii}} = XRCRG1 \cdot ( \frac{{I}_{ds}}{{V}_{dseff}} + XRCRG2 \cdot \frac{{W}_{eff} {μ}_{eff} {C}_{oxeff} {k}_{B} T}{q {L}_{eff}} ) & ( 8.1 .5 )\end{matrix}$$

The AC Model

$$\begin{matrix}Δ {Q}_{ch} ( t ) = \frac{Δ {Q}_{cheq} ( t )}{1 + j ω τ} & ( 8.1 .6 ) \\ {G}_{m} = \frac{{G}_{m0}}{1 + {ω}^{2} {τ}^{2}} + j ( - \frac{{G}_{m0} \cdot ω τ}{1 + {ω}^{2} {τ}^{2}} ) & ( 8.1 .7 ) \\ {C}_{dg} = \frac{{C}_{dg0}}{1 + {ω}^{2} {τ}^{2}} + j ( - \frac{{C}_{dg0} \cdot ω τ}{1 + {ω}^{2} {τ}^{2}} ) & ( 8.1 .8 )\end{matrix}$$

Gate Electrode Electrode and Intrinsic-Input Resistance Model

$$Rgeltd = \frac{RSHG \cdot ( XGW + \frac{{W}_{effcj}}{3 \cdot NGCON} )}{NGCON \cdot ( {L}_{drawn} - XGL ) \cdot NF} \qquad ( 8.1 .9 )$$

Charge-Deficit Non-Quasi Static Model

The Transient Model

$$\begin{matrix}{Q}_{def} ( t ) = {V}_{def} \times {C}_{fact} & ( 8.1 .1 ) \\ {i}_{D , G , S} ( t ) = {I}_{D , G , S} ( DC ) + \frac{\partial {Q}_{d , g , s} ( t )}{\partial t} & ( 8.1 .2 ) \\ {Q}_{def} ( t ) = {Q}_{cheq} ( t ) - {Q}_{ch} ( t ) & ( 8.1 .3 ) \\ \frac{\partial {Q}_{def} ( t )}{\partial t} = \frac{\partial {Q}_{cheq} ( t )}{\partial t} - \frac{{Q}_{def} ( t )}{τ} & ( 8.1 .4 a ) \\ \frac{\partial {Q}_{d , g , s} ( t )}{\partial t} = D , G , {S}_{xpart} \frac{{Q}_{def} ( t )}{τ} & ( 8.1 .4 b ) \\ \frac{1}{{R}_{ii}} = XRCRG1 \cdot ( \frac{{I}_{ds}}{{V}_{dseff}} + XRCRG2 \cdot \frac{{W}_{eff} {μ}_{eff} {C}_{oxeff} {k}_{B} T}{q {L}_{eff}} ) & ( 8.1 .5 )\end{matrix}$$

The AC Model

$$\begin{matrix}Δ {Q}_{ch} ( t ) = \frac{Δ {Q}_{cheq} ( t )}{1 + j ω τ} & ( 8.1 .6 ) \\ {G}_{m} = \frac{{G}_{m0}}{1 + {ω}^{2} {τ}^{2}} + j ( - \frac{{G}_{m0} \cdot ω τ}{1 + {ω}^{2} {τ}^{2}} ) & ( 8.1 .7 ) \\ {C}_{dg} = \frac{{C}_{dg0}}{1 + {ω}^{2} {τ}^{2}} + j ( - \frac{{C}_{dg0} \cdot ω τ}{1 + {ω}^{2} {τ}^{2}} ) & ( 8.1 .8 )\end{matrix}$$

Gate Electrode Electrode and Intrinsic-Input Resistance Model

$$\begin{matrix}Rgeltd = \frac{RSHG \cdot ( XGW + \frac{{W}_{effci}}{3 \cdot NGCON} )}{NGCON \cdot ( {L}_{drawn} - XGL ) \cdot NF} & ( 8.1 .9 ) \\ {S}_{id} ( f ) = \frac{KF \cdot {I}_{ds}^{AF}}{{C}_{oxe} {L}_{eff}^{2} {f}^{EF}} & ( 9.1 .1 ) \\ {S}_{id , lev} ( f ) = \frac{{k}_{B} {Tq}^{2} {μ}_{eff} {I}_{ds}}{{C}_{oxe} {L}_{eff}^{2} {A}_{bulk} {f}^{ef} \cdot {10}^{10}} ( NOIA log ( \frac{{N}_{0} + {N}^{a}}{{N}_{1} + {N}^{a}} ) + NOIB ( {N}_{0} - {N}_{1} ) + \frac{NOIC}{2} ( {N}_{0}^{2} - {N}_{1}^{2} ) ) + \frac{{k}_{B} {TI}_{ds}^{2} {ΔL}_{clm}}{{W}_{eff} \cdot {L}_{eff}^{2} {f}^{ef} \cdot {10}^{10}} \cdot \frac{NOLA + {NOIBN}_{i} + {NOIGN}_{i}^{2}}{{( {N}_{i} + {N}^{a} )}^{2}} & ( 9.1 .2 ) \\ {N}_{0} = {C}_{oxe} \cdot {V}_{gsteff} / q & ( 9.1 .3 ) \\ {N}_{l} = {C}_{oxe} \cdot {V}_{gsteff} \cdot ( 1 - \frac{{A}_{bulk} {V}_{dseff}}{{V}_{gsteff} + 2 {V}_{i}} ) / q & ( 9.1 .4 ) \\ {N}^{a} = {k}_{B} T \cdot ( {C }_{oxe} + {C}_{d} + CIT ) / {q}^{2} & ( 9.1 .5 ) \\ {ΔL}_{clm} = Litl \cdot log ( \frac{\frac{{V}_{ils} - {V}_{dseff}}{Litl} + EM}{{E}_{set}} ) \\ {E}_{set} = \frac{2 VSAT}{{μ}_{eff}} & ( 9.1 .6 ) \\ {S}_{id , subVt} ( f ) = \frac{NOIA \cdot {k}_{B} T \cdot {I}_{ds}^{2}}{{W}_{eff} {L}_{eff} {f}^{EF} {N}^{a2} \cdot {10}^{10}} & ( 9.1 .7 ) \\ {S}_{id} ( f ) = \frac{{S}_{id , lav} ( f ) \times {S}_{id , subvt} ( f )}{{S}_{id , subvt} ( f ) + {S}_{id , lav } ( f )} & ( 9.1 .8 )\end{matrix}$$

Channel Thermal Noise

$$\begin{matrix}\overline{{i}_{d}^{2}} = \frac{4 {k}_{B} T Δ f}{{R}_{ds} ( V ) + \frac{{L}_{eff}^{2}}{{μ}_{eff} \vert {Q}_{inv} \vert}} \cdot NTNOI & ( 9.2 .1 ) \\ {Q}_{inv} = {W}_{active} {L}_{active} {C}_{oxeff} \cdot NF \cdot & ( 9.2 .2 ) \\ [ {V}_{gsteff} - \frac{{A}_{bulk} {V}_{dseff}}{2} + \frac{{A}_{bulk}^{2} {V}_{dseff}^{2}}{12 \cdot ( {V}_{gsteff} - \frac{{A}_{bulk} {V}_{dseff}}{2} )} ] & \\ \overline{{v}_{d}^{2}} = 4 {k}_{B} T \cdot {θ}_{tnoi}^{2} \cdot \frac{{V}_{dseff} Δ f}{{I}_{ds}} & ( 9.2 .3 ) \\ \overline{{i}_{d}^{2}} = 4 {k}_{B} T {\frac{{V}_{dseff} Δ f}{{I}_{ds}} [ {G}_{ds} + {β}_{tnoi} \cdot ( {G}_{m} + {G}_{mbs} ) ]}^{2} - & ( 9.2 .4 ) \\ \overline{{v}_{d}^{2}} \cdot {( {G}_{m} + {G}_{ds} + {G}_{mbs} )}^{2} & \\ {θ}_{tnoi} = 0.37 \cdot [ 1 + TNOIB \cdot {L}_{eff} \cdot {( \frac{{V}_{gsteff}}{{E}_{sat} {L}_{eff}} )}^{2} ] & ( 9.2 .5 ) \\ {β}_{tnoi} = 0.577 \cdot [ 1 + TNOIA \cdot {L}_{eff} \cdot {( \frac{{V}_{gsteff}}{{E}_{sat} {L}_{eff}} )}^{2} ] & ( 9.2 .6 )\end{matrix}$$

Junction Diode IV Model

Source/Body Junction Diode
dioMod=0

$$\begin{matrix}{I}_{bs} = {I}_{sbs} [ exp ( \frac{{qV}_{bs}}{NJS \cdot {k}_{B} TNOM} ) - 1 ] \cdot {f}_{breakdown} + {V}_{bs} \cdot {G}_{min} & ( 10.1 .1 ) \\ {I}_{sbs} = {A}_{seff} {J}_{ss} ( T ) + {P}_{seff} {J}_{ssws} ( T ) + {W}_{effcj} \cdot NF \cdot {J}_{sswgs} ( T ) & ( 10.1 .2 ) \\ {f}_{breakdown} = 1 + XJBVS \cdot exp ( - \frac{q \cdot ( BVS + {V}_{bs} )}{NJS \cdot {k}_{B} TNOM} ) . & ( 10.1 .3 )\end{matrix}$$
dioMod=1

$$\begin{matrix}{I}_{bs} = {I}_{sbs} [ exp ( \frac{{qV}_{bs}}{NJS \cdot {k}_{B} TNOM} ) - 1 ] + {V}_{bs} \cdot {G}_{min} & ( 10.1 .4 ) \\ {I}_{bs} = {I}_{sbs} [ exp ( \frac{{qV}_{bs}}{NJS \cdot {k}_{B} TNOM} ) - 1 ] \cdot {f}_{breakdown} + {V}_{bs} \cdot {G}_{min} & ( 10.1 .5 )\end{matrix}$$

Drain/Body Junction Diode
dioMod=0

$$\begin{matrix}{I}_{bd} = {I}_{sbd} [ exp ( \frac{{qV}_{bd}}{NJD \cdot {k}_{B} TNOM} ) - 1 ] \cdot {f}_{breakdown} + & ( 10.1 .6 ) \\ {V}_{bd} \cdot {G}_{min} & \\ {I}_{sbd} = {A}_{deff} {J}_{sd} ( T ) + {P}_{deff} {J}_{sswd} ( T ) + {W}_{effcj} \cdot NF \cdot {J}_{sswgd} ( T ) & ( 10.1 .7 ) \\ {f}_{breakdown} = 1 + XJBVD \cdot exp ( - \frac{q \cdot ( BVD + {V}_{bd} )}{NJD \cdot {k}_{B} TNOM} ) & ( 10.1 .8 )\end{matrix}$$
dioMod=1

$$\begin{matrix}{I}_{bd} = {I}_{sbd} [ exp ( \frac{{qV}_{bd}}{NJD \cdot {k}_{B} TNOM} ) - 1 ] + {V}_{bd} \cdot {G}_{min} & ( 10.1 .9 ) \\ {I}_{bd} = {I}_{sbd} [ exp ( \frac{{qV}_{bd}}{NJD \cdot {k}_{B} TNOM} ) - 1 ] \cdot {f}_{breakdown} + & ( 10.1 .10 ) \\ {V}_{bd} \cdot {G}_{min} & \end{matrix}$$

Junction Diode CV Model

Source/Body Junction Diode
C_{bs}=A_{seff}C_{jbs}+P_{seff}C_{jbasw}+W_{effcj}·NF·C_{jbsswg} (10.2.1)

If Vbs<0, use equn. 10.2.2, otherwise use equn. 10.2.3

$$\begin{matrix}{C}_{jbs} = CJS ( T ) \cdot {( 1 - \frac{{V}_{bs}}{PBS ( T )} )}^{- MJS} & ( 10.2 .2 ) \\ {C}_{jbs} = CJS ( T ) \cdot ( 1 + MJS \cdot \frac{{V}_{bs}}{PBS ( T )} ) & ( 10.2 .3 )\end{matrix}$$

If Vbs<0, use equn. 10.2.4, otherwise use equn. 10.2.5

$$\begin{matrix}{C}_{jbssw} = CJSWS ( T ) \cdot {( 1 - \frac{{V}_{bs}}{PBSWS ( T )} )}^{- MJSWS} & ( 10.2 .4 ) \\ {C}_{jbssw} = CJSWS ( T ) \cdot ( 1 + MJSWS \cdot \frac{{V}_{bs}}{PBSWS ( T )} ) & ( 10.2 .5 )\end{matrix}$$

If Vbs<0, use equn. 10.2.6, otherwise use equn. 10.2.7

$$\begin{matrix}{C}_{jbsswg} = CJSWGS ( T ) \cdot {( 1 - \frac{{V}_{bs}}{PBSWGS ( T )} )}^{- MJSWGS} & ( 10.2 .6 ) \\ {C}_{jbsswg} = CJSWGS ( T ) \cdot {( 1 - \frac{{V}_{bs}}{PBSWGS ( T )} )}^{- MJSWGS} & ( 10.2 .7 )\end{matrix}$$

Drain/Body Junction Diode
C_{bd}=A_{deff}C_{jbd}+P_{deff}C_{jbdsw}+W_{effcj}·NF·C_{jbdswg} (10.2.8)

If Vbd<0, use equn. 10.2.9, otherwise use equn. 10.2.10

$$\begin{matrix}{C}_{jbd} = CJD ( T ) \cdot {( 1 - \frac{{V}_{bd}}{PBD ( T )} )}^{- MJD} & ( 10.2 .9 ) \\ {C}_{jbd} = CJD ( T ) \cdot ( 1 + MJD \cdot \frac{{V}_{bd}}{PBD ( T )} ) & ( 10.2 .10 )\end{matrix}$$

If Vbd<0, use equn. 10.2.11, otherwise use equn. 10.2.12

$$\begin{matrix}{C}_{jbdsw} = CJSWD ( T ) \cdot {( 1 - \frac{{V}_{bd}}{PBSWD ( T )} )}^{- MJSWD} & ( 10.2 .11 ) \\ {C}_{jbdsw} = CJSWD ( T ) \cdot ( 1 + MJSWD \cdot \frac{{V}_{bd}}{PBSWD ( T )} ) & ( 10.2 .12 )\end{matrix}$$

If Vbd<0, use equn. 10.2.13, otherwise use equn. 10.2.14

$$\begin{matrix}{C}_{jbdswg} = CJSWGD ( T ) \cdot {( 1 - \frac{{V}_{bd}}{PBSWGD ( T )} )}^{- MJSWGD} & ( 10.2 .13 ) \\ {C}_{jbdswg} = CJSWGD ( T ) \cdot ( 1 + MJSWGD \cdot \frac{{V}_{bd}}{PBSWGD ( T )} ) & ( 10.2 .14 )\end{matrix}$$

Layout Dependent Parasitic Models

Gate Electrode Resistance

$$Rgeltd = \frac{RSHG \cdot ( XGW + \frac{{W}_{effcj}}{3 \cdot NGCON} )}{NGCON \cdot ( {L}_{drawn} - XGL ) \cdot NF} \qquad ( 11.2 .1 )$$

Temperature Dependence Model
Temperature Dependence of Threshold Voltage

$$\begin{matrix}{V}_{sh} ( T ) = {V}_{th} ( TNOM ) + \\ ( KT1 + \frac{KT1L}{{L}_{eff}} + KT2 \cdot {V}_{bseff} ) \cdot ( \frac{T}{TNOM} - 1 )\end{matrix} \qquad ( 12.1 .1 )$$

Temperature Dependence of Mobility
U0(T)=U0(TNOM)·(T/TNOM)^{UTE} (12.2.1)
UA(T)=UA(TNOM)+UA1(T/TNOM−1) (12.2.2)
UB(T)=UB(TNOM)+UB1·(T/TNOM−1) (12.2.3)
UC(T)=UC(TNOM)+UC1·(T/TNOM−1) (12.2.4)

Temperature Dependency of Saturation Velocity
VSAT(T)=VSAT(TNOM)−AT·(T/TNOM−1) (12.3.1)

Temperature Dependency of LDD Resistance
rdsMod=0
   RDSW(T)=RDSW(TNOM)+PRT·(T/TNOM−1) (12.4.1)
   RDSWMIN(T)=RDSWMIN(TNOM)+PRT·(T/TNOM−1) (12.4.2)
rdsMod=1
RDW(T)=RDW(TNOM)+PRT·(T/TNOM−1) (12.4.3)
RDWMIN(T)=RDWMIN(TNOM)+PRT·(T/TNOM−1) (12.4.4)
RSW(T)=RSW(TNOM)+PRT·(T/TNOM−1) (12.4.5)
RSWMIN(T)=RSWMIN(TNOM)+PRT·(T/TNOM−1) (12.4.6)
Temperature Dependence of Junction Diode IV
I_{sbs}=A_{seff}Jₛₛ(T)+P_{seff}J_{ssws}(T)+W_{effcj}·NF·J_{sswgs}(T) (12.5.1)

$$\begin{matrix}{I}_{sbs} = {A}_{seff} {J}_{ss} ( T ) + {P}_{seff} {J}_{ssws} ( T ) + {W}_{effcj} \cdot NF \cdot {J}_{sswgs} ( T ) & ( 12.5 .1 ) \\ {J}_{ss} ( T ) = JSS ( TNOM ) \cdot exp ( \frac{\frac{{E}_{g} ( TNOM )}{{v}_{t} ( TNOM )} - \frac{{E}_{g} ( T )}{{v}_{t} ( T )} + XTIS \cdot ln ( \frac{T}{TNOM} )}{NJS} ) & ( 12.5 .2 ) \\ {J}_{ssws} ( T ) = JSSWS ( TNOM ) \cdot exp ( \frac{\frac{{E}_{g} ( TNOM )}{{v}_{t} ( TNOM )} - \frac{{E}_{g} ( T )}{{v}_{t} ( T )} + XTIS \cdot ln ( \frac{T}{TNOM} )}{NJS} ) & ( 12.5 .3 ) \\ {J}_{sswgs} ( T ) = JSSWGS ( TNOM ) \cdot exp ( \frac{\frac{{E}_{g} ( TNOM )}{{v}_{t} ( TNOM )} - \frac{{E}_{g} ( T )}{{v}_{t} ( T )} + XTIS \cdot ln ( \frac{T}{TNOM} )}{NJS} ) & ( 12.5 .4 )\end{matrix}$$

drain side diode
I_{sbd}=A_{deff}J_{sd}(T)+P_{deff}J_{sswd}(T)+W_{effcj}·NF·J_{sswgd}(T) (12.5.5)

$$\begin{matrix}{I}_{sbd} = {A}_{deff} {J}_{sd} ( T ) + {P}_{deff} {J}_{sswd} ( T ) + {W}_{effcj} \cdot NF \cdot {J}_{sswgd} ( T ) & ( 12.5 .5 ) \\ {J}_{sd} ( T ) = JSD ( TNOM ) \cdot exp ( \frac{\frac{{E}_{g} ( TNOM )}{{v}_{t} ( TNOM )} - \frac{{E}_{g} ( T )}{{v}_{t} ( T )} + XTID \cdot ln ( \frac{T}{TNOM} )}{NJD} ) & ( 12.5 .6 ) \\ {J}_{sswd} ( T ) = JSSWD ( TNOM ) \cdot exp ( \frac{\frac{{E}_{g} ( TNOM )}{{v}_{t} ( TNOM )} - \frac{{E}_{g} ( T )}{{v}_{t} ( T )} + XTID \cdot ln ( \frac{T}{TNOM} )}{NJD} ) & ( 12.5 .7 ) \\ {J}_{sswgd} ( T ) = JSSWGD ( TNOM ) \cdot exp ( \frac{\frac{{E}_{g} ( TNOM )}{{v}_{t} ( TNOM )} - \frac{{E}_{g} ( T )}{{v}_{t} ( T )} + XTID \cdot ln ( \frac{T}{TNOM} )}{NJD} ) & ( 12.5 .8 )\end{matrix}$$

Temperature Dependence of Junction Diode CV
source side diode
CJS(T)=CJS(TNOM)·[1+TCJ·(T−TNOM)] (12.6.1)
CJSWS(T)=CJSWS(TNOM)+TCJSW·(T−TNOM) (12.6.2)
CJSWGS(T)=CJSWGS(TNOM)·[1+TCJSWG·(T−TNOM)] (12.6.3)
PBS(T)=PBS(TNOM)−TPB·(T−TNOM) (12.6.4)
PBSWS(T)=PBSWS(TNOM)−TPBSW·(T−TNOM) (12.6.5)
PBSWGS(T)=PBSWGS(TNOM)−TPBSWG·(T−TNOM) (12.6.6)
drain side diode
CJD(T)=CJD(TNOM)·[1+TCJ·(T−TNOM)] (12.6.7)
CJSWD(T)=CJSWD(TNOM)+TCJSW·(T−TNOM) (12.6.8)
CJSWGD(T)=CJSWGD(TNOM)·[1+TCJSWG·(T−TNOM)] (12.6.9)
PBD(T)=PBD(TNOM)−TPB·(T−TNOM) (12.6.10)
PBSWD(T)=PBSWD(TNOM)−TPBSW·(T−TNOM) (12.6.11)
PBSWGD(T)=PBSWGD(TNOM)−TPBSWG·(T−TNOM) (12.6.12)
Temperature Dependences of Eg and ni
Drain Saturation Current Parameters

$$\begin{matrix}{E}_{g} ( TNOM ) = 1.16 - \frac{7.02 \times {10}^{- 4} {TNOM}^{2}}{TNOM + 1108} & ( 12.7 .1 ) \\ {E}_{g} ( T ) = 1.16 - \frac{7.02 \times {10}^{- 4} {T}^{2}}{T + 1108} & ( 12.7 .2 ) \\ {n}_{i} = 1.45 e 10 \cdot \frac{TNOM}{300.15} \cdot \sqrt{\frac{TNOM}{300.15}} \cdot exp [ 21.5565981 - \frac{{qE}_{g} ( TNOM )}{2 \cdot {k}_{B} T} ] & ( 12.7 .3 ) \\ {A}_{bulk} = \{ 1 - \frac{ⅆ {V}_{T , Long ⊥}}{ⅆ {V}_{BS , eff}} \times [ \frac{A0 \cdot {L}_{eff}}{{L}_{eff} + 2 \sqrt{XJ \cdot {X}_{dep}}} \times ( 1 - AGS \cdot {{V}_{GST , eff} ( \frac{{L}_{eff}}{{L}_{eff} + 2 \sqrt{XJ \cdot {X}_{dep}}} )}^{2} ) + \frac{B0}{{W}_{eff} + B1} ] \} \times \frac{1}{1 + KETA \cdot {V}_{BS , eff}} \\ where \\ \frac{ⅆ {V}_{T , Long ⊥}}{ⅆ {V}_{BS , eff}} = \sqrt{1 + \frac{LPEB}{{L}_{eff}}} \times \frac{K1}{2 \sqrt{2 {Φ}_{f} - {V}_{BS , eff}}} \frac{TOXE}{TOXM} + K2 \frac{TOXE}{TOXM} - K3 \times \frac{TOXE}{{W}_{eff} + W0} 2 {Φ}_{f} & 14.1\end{matrix}$$

1. A method for extracting semiconductor device model parameters, comprising:
obtaining terminal current data corresponding to various bias conditions in a set of test devices;
extracting Vₜₕ related parameters based on the terminal current data;
and
extracting I_{gb} related parameters based on the terminal current data and the extracted Vₜₕ related parameters.

2. The method of claim 1, wherein the terminal current data comprises one or more I_{g} v. V_{bs} curves, and wherein extracting I_{gb} related parameters comprises:
extracting Aigbacc, Bigbacc, and Cigbacc using non-linear square fit and the one or more I_{g} v. V_{bs} curves; and
extracting Nigbacc using said extracted Aigbacc, Bigbacc, and Cigbacc and linear interpolation using maximum slope position in the one or more I_{g} vs. V_{bs} curves.

3. The method of claim 1, wherein the terminal current data comprises one or more I_{b} v. V_{gs} curves, and wherein extracting I_{gb} related parameters comprises:
extracting Aigbinv, Biginv, and Ciginv using non-linear square fit and the one or more I_{b} v. V_{gs} curves; and
extracting NIgbinv and Eigbinv using the extracted Aigbinv, Bigbinv, and Cigbinv and mathematical optimization.

4. A method for extracting semiconductor device model parameters, comprising:
obtaining terminal current data corresponding to various bias conditions in a set of test devices;
extracting Vₜₕ related parameters; and
extracting I_{gidl} related parameters based on the terminal current data and the Vₜₕ related parameters.

5. The method of claim 3, wherein the terminal current data comprises I_{b} v. V_{gs} curves, and wherein extracting I_{gidl} related parameters further comprises:
extracting CGIDL based on the I_{b} vs V_{gs} curves for varying V_{ds};
extracting AIGDL and BIGDL using non-linear square fit; and
optimizing said AIGDL and said BIGDL to extract EGIDL.

6. A method for extracting semiconductor device model parameters comprising:
obtaining terminal current data corresponding to various bias conditions in a set of test devices;
extracting Vₜₕ related parameters; and
extracting I_{gd} and I_{gs} related parameters based on the terminal current data and the extracted Vₜₕ related parameters.

7. The method of claim 5, wherein the terminal current data comprises I_{d} v. V_{gs} and Iₛ v. V_{gs} curves measured with V_{ds}=0 and V_{bs}=0 on one or more devices having a maximum L_{drawn}*W_{drawn} among the set of test devices, and wherein extracting I_{gc} related parameters further comprises:
extracting AIGSD, BIGSD, and CIGSD using non-linear square fit method and the I_{d} v. V_{gs} and Iₛ v. V_{gs} curves.

8. The method of claim 6, wherein extracting I_{gd} and I_{gs} related parameters further comprises:
setting POXEDGE, TOXREF, and NTOX to their default values and setting DLCIG equal to 0.7 *Xⱼ before extracting AIGSD, BIGSD, and CIGSD; and extracting DLCIG after extracting AIGSD, BIGSD, and CIGSD.

9. The method of claim 5, further comprising extracting I_{gc} related parameters by:
obtaining I_{g} v. V_{gs} curves for devices having a maximum L_{drawn}*W_{drawn} among the set of test devices;
removing I_{gs} and I_{gd} effects from the I_{g} v V_{gs} curves using the extracted I_{gd} and I_{gs} related parameters;
extracting AIGC, BIGC, and CIGC using non-linear square fit and the I_{g} v. V_{gs} curves; and
extracting NIGC at V_{gs}=Vₜₕ using linear interpolation.
and
dividing I_{gc} into its two components, I_{gcs} and I_{gcd}.

10. A method for extracting semiconductor device model parameters comprising:
loading measurement data;
extracting Vₜₕ related parameters;
using the extracted Vₜₕ related parameters to extract L_{eff}, R_{d} and Rₛ related parameters;
using the extracted Vₜₕ related parameters to extract mobility and W_{eff} related parameters;
using the extracted Vₜₕ, L_{eff}, mobility, and W_{eff} related parameters to extract Vₜₕ geometry related parameters;
using the extracted Vₜₕ, L_{eff}, R_{d} Rₛ, mobility, and W_{eff} related parameters to extract sub-threshold region related parameters;
using the extracted Vₜₕ related parameters to extract drain induced barrier lower related parameters;
using the extracted Vₜₕ, L_{eff}, R_{d}, Rₛ, mobility, W_{eff}, sub-threshold region, and drain induced barrier lower related parameters to extract I_{dsat} related parameters; and
extracting additional DC related parameters.

11. The method of claim 9, wherein the L_{eff}, R_{d} and Rₛ related parameters, the Vₜₕ geometry related parameters, the subthreshold region related parameters, and the drain induced barrier lower related parameters are extracted using linear region I_{d} v. V_{gs} curves constructed based on the measurement data.

12. The method of claim 9, wherein the I_{dsat} related parameters are extracted using saturation region I_{d} v. V_{ds} curves constructed based on the measurement data.

13. The method of claim 9, wherein extracting additional DC parameters further comprises:
extracting Iᵢᵢ related parameters; and
extracting junction related parameters.

14. The method of claim 12, wherein the Iᵢᵢ related parameters are extracted using linear region I_{d} v. V_{gs} curves constructed based on the measurement data and the junction related parameters are extracted using C_{bs} V. V_{bs} curves and C_{bd} v. V_{bs} curves constructed based on the measurement data.

15. A method of extracting I_{gidl} related parameters for modeling a MOSFET device, comprising:
obtaining terminal current data corresponding to various bias conditions in a set of test devices, the terminal current data including I_{b} vs V_{gs} curves measured on the set of test devices;
extracting CGIDL using the I_{b} vs V_{gs} curves;
extracting AIGDL and BIGDL using non-linear square fit; and
optimizing said AIGDL and said BIGDl to extract EGIDL.

16. A method for extracting semiconductor device model parameters comprising:
obtaining terminal current data corresponding to various bias conditions in a set of test devices;
extracting I_{gb} related parameters, I_{gidl} related parameters, I_{gd} and I_{gs} related parameters, and I_{gc} related parameters from the terminal current data;
modifying the terminal current data using the I_{gb} related parameters, I_{gidl} related parameters, I_{gd} and I_{gs} related parameters, and I_{gc} related parameters; and
extracting additional DC parameters using the modified terminal current data.

17. The method of claim 15, wherein extracting additional DC parameters further comprises:
extracting L_{eff}, R_{d} and Rₛ related parameters;
extracting mobility and W_{eff} related parameters;
using the extracted L_{eff}, mobility and W_{eff} related parameters to extract Vₜₕ geometry parameters;
using the extracted L_{eff}, R_{d} and Rₛ, mobility and W_{eff} related parameters to extract sub-threshold region related parameters;
extracting DIBL related parameters; and
using the extracted L_{eff}, R_{d} and Rₛ, mobility and W_{eff} Vₜₕ geometry, sub-threshold region and DIBL related parameters to extract I_{dsat} related parameters

18. The method of claim 16, wherein extracting additional DC parameters further comprising:
extracting Iᵢᵢ related parameters; and
extracting junction related parameters.

19. A computer readable medium comprising computer executable program instructions that when executed cause a digital processing system to perform a method for extracting semiconductor device model parameters, the method comprising:
obtaining terminal current data corresponding to various bias conditions in a set of test devices;
extracting I_{gb} related parameters, I_{gidl} related parameters, I_{gd} and I_{gs} related parameters, and I_{gc} related parameters from the terminal current data;
modifying the terminal current data using the extracted I_{diode} related parameters and I_{bjt} related parameter extracting I_{gb} related parameters, I_{gidl} related parameters, I_{gd} and I_{gs} related parameters, and I_{gc} related parameters; and
extracting additional DC parameters from the modified terminal current data.

20. A system for extracting semiconductor device model parameters, comprising:
a central processing unit (CPU);
a port or I/O device communicating with the central processing unit to provide terminal current data to the CPU corresponding to various bias conditions in a set of test devices;
a memory communicating with the CPU and storing therein program instructions executable by the CPU to extract I_{gb} related parameters, I_{gidl} related parameters, I_{gd} and I_{gs} related parameters, and I_{gc} related parameters from said terminal current data, to modify said terminal current data based on the extracted I_{gb} related parameters, I_{gidl} related parameters, I_{gd} and I_{gs} related parameters, and I_{gc} related parameters, and to extract DC parameters based on said modified terminal current data.

21. The system according to claim 19, wherein said memory also stores program instructions executable by the CPU to:
extract Vₜₕ related parameters;
use the extracted Vₜₕ related parameters to extract L_{eff}, R_{d} and Rₛ related parameters;
use the extracted Vₜₕ related parameters to extract mobility and W_{eff} related parameters;
use the extracted Vₜₕ, L_{eff}, R_{d}, Rₛ, mobility and W_{eff} related parameters to extract sub-threshold region related parameters;
use the extracted Vₜₕ related parameters to extract drain induced barrier lower related parameters; and
use the extracted Vₜₕ, L_{eff}, R_{d}, Rₛ, mobility, W_{eff}, sub-threshold region, and drain induced barrier lower related parameters to extract I_{dsat} related parameters.
